(19) United States
(12) Patent Application Publication
(10) Pub. No.: US 2010/0157107 A1
(43) Pub. Date: Jun. 24, 2010

(54) Image Apparatus And Electronic Apparatus

(75) Inventors: Yasuhiro IIJIMA, Osaka (JP); Hideto FUJITA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/642,115

(22) Filed: Dec. 18, 2009

(30) Foreign Application Priority Data
Dec. 20, 2008 (JP) 2008-324812

(51) Int. Cl. H04N 5/262

(52) U.S. Cl. 348/240.99; 348/E05.055

(57) ABSTRACT

A clipping set portion includes: a main object detection portion which detects a main object in an input image and generates main object position information; a clipping region set portion which sets a clipping region for the input image based on the main object position information; and a zoom information generation portion which generates zoom information based on zoom intention information from a user input via an operation portion. The zoom intention information is information which is input via the operation portion at a time of taking the input image and indicates whether or not to perform a zoom process.

This nonprovisional application claims priority under 35 U.S.C. §119(a) on Patent Application No. 2008-324812 filed in Japan on Dec. 20, 2008, the contents of which are hereby incorporated by reference.

### BACKGROUND OF THE INVENTION

1. Field of the Invention

The present invention relates to an image apparatus which takes and generates an image, and to an electronic apparatus which reproduces and edits the taken image.

2. Description of Related Art

In recent years, image apparatuses such as a digital still camera, a digital video camera and the like which take an image by using an image sensor like a CCD (Charge Coupled Device), a CMOS (Complimentary Metal Oxide Semiconductor) sensor or the like have been widespread. As these image apparatuses, there are apparatuses that are able to not only control a zoom lens but also perform a zoom process by carrying out an image process.

For example, in a case where a zoom-in process (enlargement process) is performed, an image apparatus is operated so as to allow an object to be confined in an angle of view, that is, view angle, of an image (enlarged image) after the zoom-in process. Here, because a user cannot obtain a desired image if the object goes out of the view angle of the enlarged image, the user needs to concentrate on operation of the image apparatus. Accordingly, it becomes difficult for the user to take action (e.g., communication such as a dialogue and the like with the object) other than the operation of the image apparatus.

To deal with this problem, there has been proposed an image apparatus which records information about a taken image and an enlargement process and obtains an enlarged image by performing the enlargement process at a time of reproduction.

However, in such an image apparatus, it is necessary to decide on a view angle at a time of taking an image. Accordingly, the user needs to make sure that the object is surely confined in the view angle of an enlarged image at the time of taking an image. Besides, at a time of reproduction, to change the view angle that is set at the time of taking the image, it is necessary to reset the view angle of the enlarged image, which results in a onerous operation.

### SUMMARY OF THE INVENTION

An image apparatus according to the present invention includes:

an image portion which generates an input image by taking an image;

a clipping set portion which generates relevant information related to the input image;

a recording portion which relates the relevant information to the input image and records the relevant information; and

an operation portion which inputs a command from a user;

wherein the clipping set portion includes a zoom information generation portion which generates zoom information that is a piece of information of the relevant information based on a command which indicates whether or not to apply a zoom process to the input image that is input via the operation portion at a time of taking the input image.

An electronic apparatus according to the present invention includes:

a clipping process portion which based on relevant information related to an input image, sets a display region in the input image, and based on an image in the display region, generates an output image;

wherein

a piece of information of the relevant information is zoom information which indicates whether or not to apply a zoom process to the input image; and

the clipping process portion sets the display region based on the zoom information.

### BRIEF DESCRIPTION OF THE DRAWINGS

FIG. 1 is a block diagram showing a structure of an image apparatus according to an embodiment of the present invention;

FIG. 2 is a block diagram showing a structure of a clipping set portion;

FIG. 3 is a schematic view of an image showing an example of a face detection process method;

FIG. 4 is a schematic view describing an example of a tracking process;

FIG. 5 is a schematic view of an input image showing an example of a method for setting a clipping region;

FIG. 6A is a diagram showing a method for dividing an input image;

FIG. 6B is a diagram showing specifically a calculation example of an evaluation value of tracking reliability;

FIG. 7 is a diagram showing an example of a clipping region set by a clipping region set method in a first example;

FIG. 8 is a diagram describing a coordinate of an image;

FIG. 9A is a diagram showing a main object region in an input image;

FIG. 9B is a diagram showing a clipping region set in an input image;

FIG. 10A is a diagram showing examples of an input image and a clipping region before a positional adjustment;

FIG. 10B is a diagram showing examples of an input image and a clipping region after a positional adjustment;

FIG. 11 is a diagram showing an example of a clipping region set by a clipping region set method in a second example;

FIG. 12A is a diagram showing a specific example of zoom information generated;

FIG. 12B is a diagram showing a specific example of zoom information generated;

FIG. 12C is a diagram showing a specific example of zoom information generated;

FIG. 13 is a block diagram showing a structure of a clipping process portion;

FIG. 14 is a diagram showing a clipping process in a first example;

FIG. 15 is a diagram showing a method for setting a display region in the first example;

FIG. 16 is a diagram showing a method for setting a display region in the second example;

FIG. 17 is a diagram showing a method for setting a display region in a third example;

FIG. 18 is a block diagram showing a basic portion of an image apparatus which includes a dual codec system;

FIG. 19 is a block diagram showing a basic portion of another example of an image apparatus which includes a dual codec system;

FIG. 20 is a diagram showing examples of an input image and a clipping region which is set;

FIG. 21A is a diagram showing a clipped image obtained from a input image;

FIG. 21B is a diagram showing a reduced image obtained from an input image;

FIG. 22 is a diagram showing an example of an enlarged image;

FIG. 23 is a diagram showing an example of a combined image;

FIG. 24 is a diagram showing examples of a combined image and a display region that is set;

FIG. 25 is a diagram showing an example of an output image;

FIG. 26A is a graph showing brightness distribution of an object whose image is taken;

FIG. 26B is a taken image of the object shown in FIG. 26A;

FIG. 26C is a taken image of the object shown in FIG. 26A;

FIG. 26D is an image which is obtained by deviating the image shown in FIG. 26C by a predetermined distance;

FIG. 27A is a diagram showing a method of estimating a high-resolution image from a low-resolution raw image, that is, an original image;

FIG. 27B is a diagram showing a method for estimating a low-resolution estimated image from a high-resolution image;

FIG. 27C is a diagram showing a method for generating a difference image from a low-resolution estimated image and a low-resolution raw image;

FIG. 27D is a diagram showing a method for rebuilding a high-resolution image from a high-resolution image and a difference image;

FIG. 28 is a schematic diagram showing a method for dividing each region of an image by a representative point matching method;

FIG. 29A is a schematic diagram of a reference image showing a representative point matching method;

FIG. 29B is a schematic diagram of a non-reference image showing a representative point matching method;

FIG. 30A is a schematic diagram of a reference image showing single-pixel movement amount detection;

FIG. 30B is a schematic diagram of a non-reference image showing single-pixel movement amount detection;

FIG. 31A is a graph showing a horizontal-direction relationship between pixel values of a representative point and a sampling point when single-pixel movement amount detection is performed; and

FIG. 31B is a graph showing a vertical-direction relationship between pixel values of a representative point and a sampling point when single-pixel movement amount detection is performed.

### DETAILED DESCRIPTION OF PREFERRED EMBODIMENTS

An embodiment of the present invention is described below with reference to drawings. First, an image apparatus that is an example of the present invention is described. The image apparatus described below is an image apparatus such as a digital camera or the like which is capable of recording a sound, a moving image and a still image.

<<Image Apparatus >>

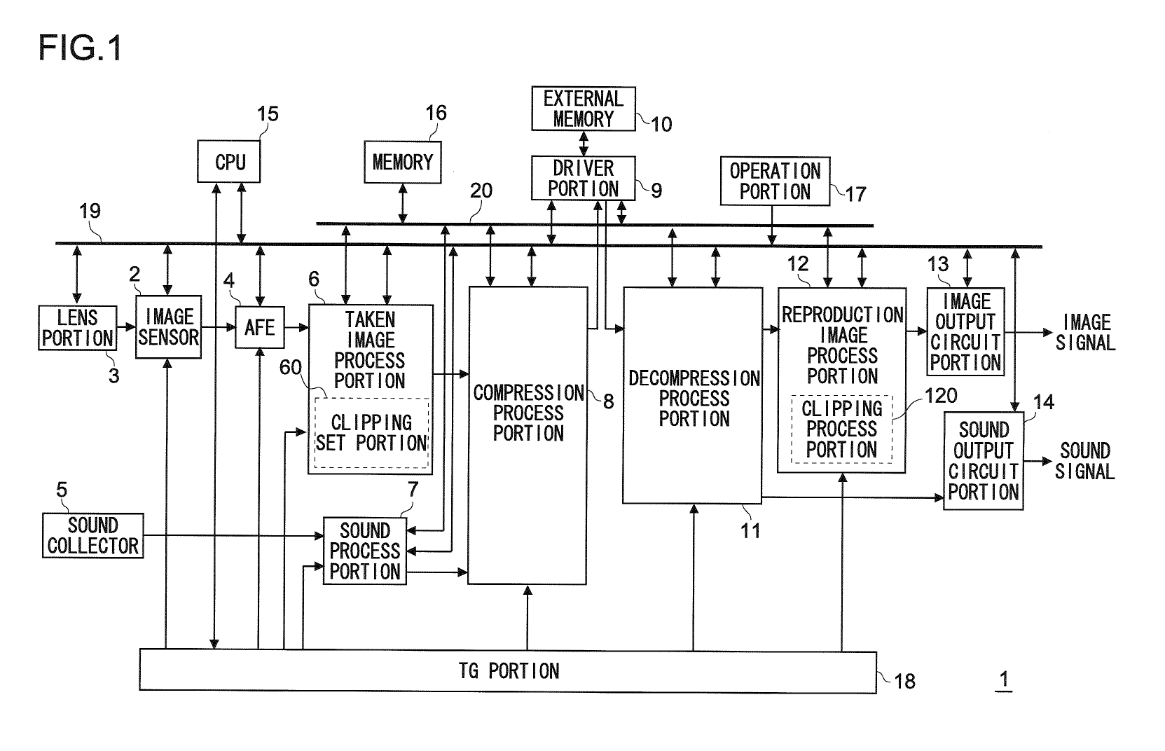

First, a structure of the image apparatus is described with reference to FIG. 1. FIG. 1 is a block diagram showing a structure of the image apparatus according to an embodiment of the present invention.

As shown in FIG. 1, an image apparatus 1 includes: an image sensor 2 which is composed of a solid-state image taking device such as a CCD or a CMOS sensor that transduces an input optical image into an electrical signal; and a lens portion 3 which forms an optical image of an object on the image sensor 2 and adjusts the amount of light and the like. The lens portion 3 and the image sensor 2 constitute an image taking portion, and this image taking portion generates an image signal. The lens portion 3 includes various lenses (not shown) such as a zoom lens, a focus lens and the like and a stop (not shown) that adjusts the amount of light input into the image sensor 2.

Besides, the image apparatus 1 includes: an AFE (Analog Front End) 4 which transduces an image signal that is an analog signal output from the image sensor 2 into a digital signal and adjusts a gain; a sound collector 5 which transduces an input sound into an electrical signal; a taken image process portion 6 which applies various types of image processes to an image signal; a sound process portion 7 which transduces a sound signal that is an analog signal output from the sound collector 5 into a digital signal; a compression process portion 8 which applies a compression coding process for still images such as a JPEG (Joint Photographic Experts Groups) compression method or the like to an image signal output from the taken image process portion 6 and applies a compression coding process moving images such as a MPEG (Moving Picture Experts Group) compression method or the like to an image signal output from the taken image process portion 6 and to a sound signal output from the sound process portion 7; an external memory 10 which records a compression-coded signal that undergoes a compression coding process performed by the compression process portion 8; a driver portion 9 which records and reads an image signal into and from the external memory 10; and a decompression process portion 11 which decompresses and decodes a compression-coded signal that is read from the external memory 10 by the driver portion 9. The taken image process portion 6 includes a clipping set portion 60 which performs various types of setting for applying a clipping process to an input image signal.

Moreover, the image apparatus 1 includes: a reproduction image process portion 12 which generates an image signal for reproduction based on an image signal decoded by the decompression process portion 11 and on an image signal output from the taken image process portion 6; an image output circuit portion 13 which converts an image signal output from the reproduction image process portion 12 into a signal in a form that is able to be displayed on a display device (not shown) such as a display or the like; and a sound output circuit portion 14 which converts a sound signal decoded by the decompression process portion 11 into a signal in a form that is able to be reproduced by a reproduction device (not shown) such as a speaker or the like. The reproduction image process portion 12 includes a clipping process portion 120 which clips a portion of an image represented by an input image signal to generate a new image signal.

In addition, the image apparatus 1 includes: a CPU (Central Processing Unit) 15 which controls the overall operation within the image apparatus 1; a memory 16 which stores programs for performing different types of processes and temporarily stores a signal when a program is executed; an operation portion 17 which has a button for starting to take an image and a button for deciding on various types of setting and the like and into which a command from a user is input; a timing generator (TG) portion 18 which outputs a timing control signal for synchronizing operation timings of various portions with each other; a bus 19 through which signals are exchanged between the CPU 15 and various portions; and a bus 20 through which signals are exchanged between the memory 16 and various portions.

As the external memory 10, any recording medium may be used as long as it is able to record image signals and sound signals. For example, semiconductor memories such as a SD (Secure Digital) card and the like, an optical discs such as a DVD and the like, magnetic discs such as a hard disc and the like are able to be used as this external memory 10. The external memory 10 may be formed to be removable from the image apparatus 1.

Next, basic operation of the image apparatus 1 is described with reference to FIG. 1. First, the image apparatus 1 applies photoelectric transducing to light input from the lens portion 3 at the image sensor 2, thereby obtaining an image signal that is an electrical signal. And, the image sensor 2 successively outputs image signals to the AFE 4 at predetermined frame periods (e.g., 1/30 second) in synchronization with a timing control signal input from the TG portion 18. Then, the image signal that is converted by the AFE 4 from an analog signal to a digital signal is input into the taken image process portion 6.

In the taken image process portion 6, various image processes such as gradation correction, contour accentuation and the like are performed. An image signal of a RAW image (an image in which each pixel has a signal value for a single color) that is input into the taken image process portion 6 is subjected to “demosaicing,” that is, a color inperpolation process, and is thus converted into an image signal for a demosaiced image (an image in which each pixel has signal values for a plurality of colors). The memory 16 operates as a frame memory, and temporarily stores an image signal when the taken image process portion 6 performs its process. The demosaiced image may have, for example, in one pixel, signal values for R (red), G (green) and B (blue) or may have signal values for Y (brightness), U and V (color difference).

Here, in the lens portion 3, based on the image signal input into the taken image process portion 6, positions of various lenses are adjusted and thus the focus is adjusted, and an opening degree of the stop is adjusted and thus the exposure is adjusted. Moreover, based on the input image signal, white balance is also adjusted. The adjustments of the focus, the exposure and the white balance are automatically performed based on a predetermined program so as to allow their optimum states to be achieved or they are manually performed based on a command from the user.

Besides, based on an input image signal or a command from the user, the clipping set portion 60 disposed in the taken image process portion 6 generates and outputs various relevant information that is necessary to perform a clipping process. The relevant information is related to the image signal. In relating the relevant information to the image signal, the relevant information may be contained in a region of the header or subheader of the image signal for direct relating. In addition, the relevant information may be prepared as a separate file and indirectly related to the image signal. Incidentally, a structure and operation of the clipping set portion 60 are described in detail later.

When recording a moving image, not only an image signal but also a sound signal are recorded. The sound signal which is transduced into an electrical signal and output by the sound collector 5 is input into the sound process portion 7, where the signal is digitized and is objected to a noise removal process. Then, the image signal output from the taken image process portion 6 and the sound signal output from the sound process portion 7 are input into the compression process portion 8, where they are compressed by a predetermined compression method. Here, the image signal and the sound signal are related to each other in a time-wise fashion and so formed as not to deviate from each other during a time of reproduction. Then, the compressed image signal and sound signal are recorded into the external memory 10 via the driver portion 9. Besides, the various relevant information output from the clipping set portion 60 is also recorded.

On the other hand, in a case where only a still image and a sound are recorded, either the image signal or the sound signal is compressed by the compression process portion 8 with a predetermined compression method and recorded into the external memory 10. The process performed by the taken image process portion 6 may be different depending on whether a moving image is recorded or a still image is recorded.

The compressed image signal and sound signal which are recorded in the external memory 10 are read by the decompression process portion 11 based on a command from the user. In the decompression process portion 11, the compressed image signal and sound signal are decompressed. The decompressed image signal is input into the reproduction image process portion 12, where an image signal for reproduction is generated.

Here, based on the various relevant information generated by the clipping set portion 60, the command from the user and the like, the clipping process portion 120 clips a portion of the input image signal to generate a new image signal. A structure and operation of the clipping process portion 120 are described later in detail.

The image signal output from the reproduction image process portion 12 is input into the image output circuit portion 13. The sound signal decompressed by the decompression process portion 11 is input into the sound output circuit portion 14. Then, in the image output circuit portion 13 and the sound output circuit portion 14, the image signal and the sound signal are converted into signals and output in forms that are able to be displayed on the display device or in forms that are able to be reproduced by the speaker.

The display device and the speaker may be formed unitarily with the image apparatus 1, or may be formed separately and connected to the image apparatus 1 by using terminals, cables or the like of the image apparatus 1. A display device which is unitarily formed with the image apparatus 1 is especially called a monitor below.

In a time of a preview, that is, a time the user checks an image displayed on the display device without recoding the image signal, the image signal output from the taken image process portion 6 may be output into the image output circuit portion 13 without being compressed. Besides, in recording the image signal of a moving image, at the same time the image signal is compressed by the compression process portion 8 and recorded into the external memory 10, the image signal may be input into the image output circuit portion 13 and displayed on the monitor.

Besides, before the clipping set portion 60 processes the image signal, hand-vibration correction may be performed. As the hand-vibration correction, optical hand-vibration correction which drives, for example, the image portion (the lens portion 3 and the image sensor 2) to cancel motion (vibration) of the image apparatus 1 may be employed. In addition, electronic hand-vibration correction may be employed, in which the taken image process portion 6 applies an image process for canceling motion of the image apparatus 1 to the input image signal. Moreover, to detect motion of the image apparatus 1, a sensor such as a gyroscope or the like may be used, or the taken image process portion 6 may detect motion based on the input image signal.

A combination of the taken image process portion 6 and the reproduction image process portion 12 is able to be construed as an image process portion (an image process device).

<Clipping Set Portion>

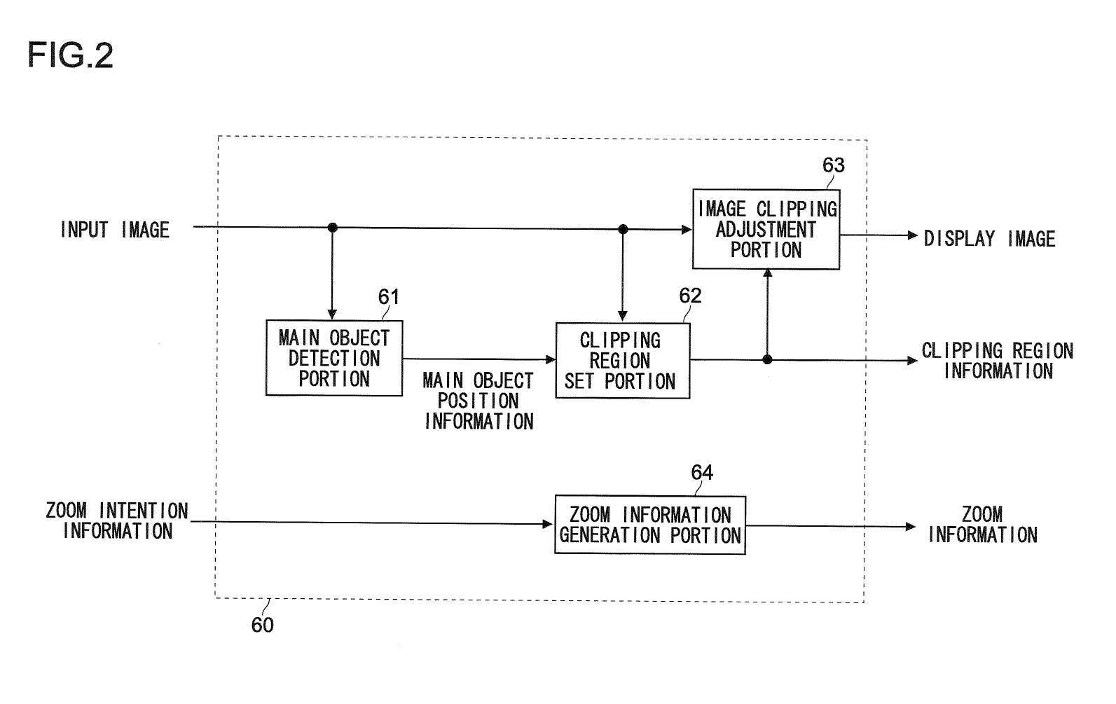

Next, a structure of the clipping set portion 60 shown in FIG. 1 is described with reference to drawings. FIG. 2 is a block diagram showing a structure of the clipping set portion. In the following description, for specific description, an image signal which is input into the clipping set portion 60 is represented as an image called an “input image.” An input image signal may be a demosaiced image. In some cases, a view angle of an input image is represented as a total view angle in the following description.

As shown in FIG. 2, the clipping set portion 60 includes: a main object detection portion 61 which detects an object (hereinafter, called a main object), an image of which the user especially desires to take, from an input image and outputs main object position information that indicates a position of the main object in the input image; a clipping region set portion 62 which based on the main object position information output from the main object detection portion 61, sets a clipping region for the input image and outputs clipping region information; an image clipping adjustment portion 63 which based on the clipping region information, clips an image in the clipping region from the input image, adjusts the clipped image and outputs the clipped image as a display image; and a zoom information generation portion 64 which generates zoom information based on zoom intention information which is input via the operation portion 17 from the user.

The clipping region information is information which indicates, for example, a position and a size in an input image of a clipping region that is a partial region in the input image. The clipping region is a region which is highly likely to be especially needed in the input image by the user for functions such as a function to contain the main object and the like. The clipping region is selected and set by the user or automatically set.

The zoom information is information (relevant information) which is related to the input image and indicates a user's intention to or not to apply a zoom process (zoom in or zoom out) to the input image. For example, when the user desires to perform a zoom process during a time of recording an image, zoom information is generated based on zoom intention information input via the operation portion 17.

The zoom process means what is called an electronic zoom process which is performed by implementing an image process. Specifically, a between-pixels interpolation process (nearest neighbor interpolation, bi-linear interpolation, bi-cubic interpolation and the like) or a super-resolution process is applied to a partial region of the input image, so that the number of pixels is increased to perform an enlargement process (zoom in). Besides, for example, a pixel addition process or a thin-out process is applied to an image in a region of the input image, so that the number of pixels is decreased to perform a reduction process (zoom out).

Here, the image clipping adjustment portion 63 may not be disposed in the clipping set portion 60. In other words, a display image may not be generated nor output.

[Main Object Detection Portion]

The main object detection portion 61 detects a main object from the input image.

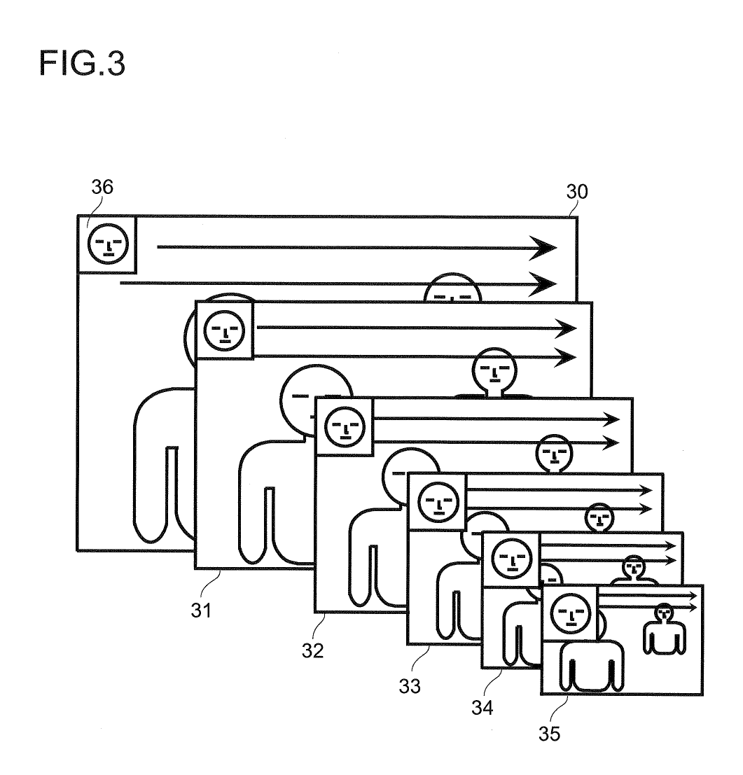

For example, the main object detection portion 61 detects the main object by applying a face detection process to the input image. An example of the face detection process method is described with drawings. FIG. 3 is a schematic diagram of an image showing an example of the face detection process method. The method shown in FIG. 3 is only an example, and any known method may be used as the face detection process method.

In the present example, the input image and a weight table are compared with each other, and thus a face is detected. The weight table is obtained from a large number of teacher samples (face and non-face sample images). Such a weight table can be made by using, for example, a known learning method called “Adaboost” (Yoav Freund, Robert E. Schapire, “A decision-theoretic generalization of on-line learning and an application to boosting”, European Conference on Computational Learning Theory, Sep. 20, 1995). This “Adaboost” is one of adaptive boosting learning methods in which, based on a large number of teacher samples, a plurality of weak discriminators that are effective for discrimination are selected from a plurality of weak discriminator candidates; and they are weighted and integrated to achieve a high-accuracy discriminator. Here, the weak discriminator means a discriminator which has a discrimination capability higher than discrimination by total accident but is not as highly accurate as it meets a sufficient accuracy. In a time of selecting a weak discriminator, if there is already a selected weak discriminator, learning is focused on the teacher samples which the selected weak discriminator erroneously recognizes, so that the most effective weak discriminator is selected from the remaining weak discriminator candidates.

As shown in FIG. 3, first, for-face-detection reduced images 31 to 35 with a reduction factor of, for example, 0.8 are generated from an input image 30 and are then arranged hierarchically. The size of a determination region 36 which is used for determination in the images 30 to 35 is the same for all the images 30 to 35. And as indicated by arrows in the Figure, the determination region 36 is moved from left to right on each image to perform horizontal scanning. Besides, this horizontal scanning is performed from top to bottom to scan the entire image. Here, a face image that matches the determination region 36 is detected. In addition to the input image 30, the plurality of for-face-detection reduced images 31 to 35 are generated, which allows different-sized faces to be detected by using one kind of weight table. Moreover, the scanning order is not limited to the order described above, and the scanning may be performed in any order.

The matching process includes a plurality of determination steps which are performed successively from rough determination to fine determination. If no face is detected in a determination step, the process does not go to the next determination step, and it is determined that there is no face in the determination region 36. If and only if a face is detected in all the determination steps, it is determined that a face is in the determination region 36, and the determination region is scanned; then the process goes to a determination step in the next determination region 36. Although a front face is detected in the example described above, a face direction or the like of the main object may be detected by using a side face sample and the like. Besides, a face recognition process may be performed, in which the face of a specific person is recorded as a sample, and the specific person is detected as the main object. In the above example, the face of a person is detected; however, faces of animals and the like other than persons may be detected.

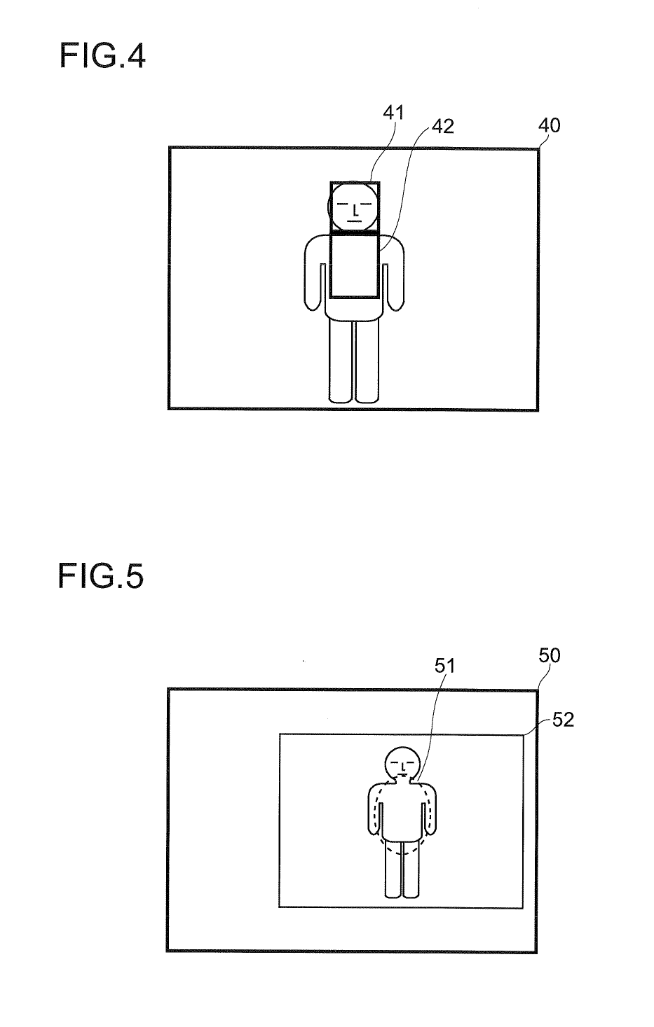

Besides, the main object detection portion 61 is capable of continuing a process to detect main objects from input images that are successively input, that is, what is called a tracking process. For example, a tracking process described below may be performed; an example of this tracking process is described with reference to drawings. FIG. 4 is a schematic view describing an example of the tracking process

The tracking process shown in FIG. 4 uses a result of the above face detection process, for example. As shown in FIG. 4, in the tracking process in this example, first, a face region 41 of the main object is detected from an input image 40 by the face detection process. Then, at a position which is under (in a direction from the middle of the eyebrows to the mouth) the face region 41 and next to the face region 41, a body region 42 which contains the main object's body is set. Then, the body region 42 is successively detected from the input image 40 which is successively input, so that the tracking process of the main object is performed. Here, the tracking process is performed based on color information of the body region 42 (e.g., signal values which indicate colors, that is, color difference signals U and V, RGB signals, H signals of H (hue), S (saturation), and B (brightness) and the like). Specifically, for example, in the time of setting the body region 42, the color of the body region 42 is recognized and stored; a region having a color similar to the recognized color is detected from the input image that is input thereafter; thus, the tracking process is performed.

By performing the tracking process by means of the above method or the like, the body region 42 of the main object is detected from the input image. The main object detection portion 61 outputs, for example, the positions of the detected body region 42 and the face region 41 in the input image as main object position information.

Note that the above face detection process and the tracking process are merely examples, and any other methods may be used to perform the face detection process and tracking process. For example, a template method may be used, in which a pattern to be tracked is set in advance and the pattern is detected from an input image. Besides, an optical flow method may be used, in which distribution of apparent speeds of a main object on an image is calculated to obtain movement of the main object.

[Clipping Region Set Portion]

The clipping region set portion 62 sets a clipping region based on main object position information. A specific example of a clipping region set method is described with reference to drawings.

As shown in FIG. 5, a clipping region 52 is set so as to allow the clipping region 52 to contain a region (main object region) 51 where a main object indicated by main object position information is present. For example, the clipping region 52 is set so as to allow the main object region 51 to be located at the center portion in a horizontal direction (a left-to-right direction in the drawing) of the clipping region 52 and at the center position in a vertical direction (a top-to-bottom direction in the drawing) of the clipping region 52.

Here, the size (the number of pixels in the region) of the clipping region 52 may be a predetermined size. Besides, in FIG. 5, the main object region 51 is set by using the body region of the main object; however, the main object region may be set by using the face region. In a case where the face region itself is used as the main object region, the clipping region 52 may be set so as to allow the face region to be located at the center portion in the horizontal direction of the clipping region 52 and at a position one-third the vertical-direction length of the clipping region 52 away from the top of the clipping region 52.

In addition, the size of the clipping region 52 may depend on the size of the main object region 51. Hereinafter, a specific example of a set method in a case where the clipping region 52 is variable is described.

### First Example

### Clipping Region Set Method

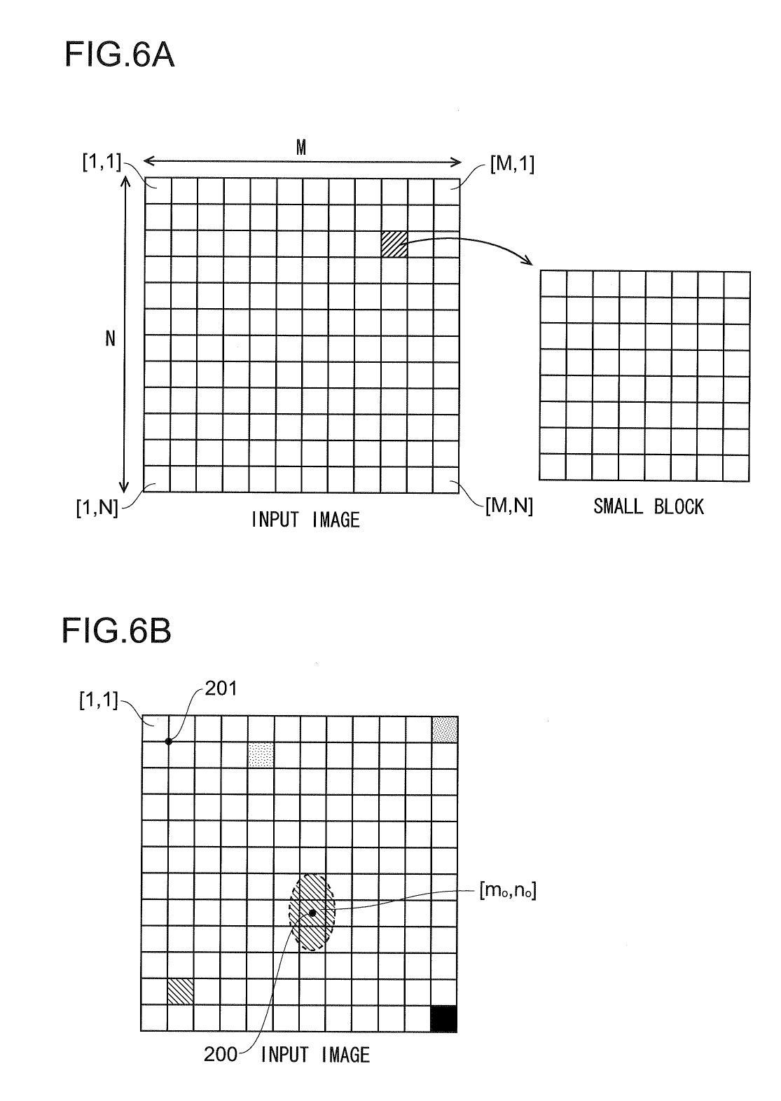

In the present example, the size of a clipping region is set depending on detection accuracy (tracking reliability) of a main object. The tracking reliability means accuracy of a tracking process: for example, the tracking reliability is able to be represented by a tracking-reliability evaluation value as described below. A method for calculating a tracking-reliability evaluation value is described with reference to drawings. FIGS. 6A and 6B are diagrams showing method examples for calculating a tracking-reliability evaluation value. FIG. 6A shows a method for dividing an input image; and FIG. 6B is a diagram showing specifically a calculation example of a tracking-reliability evaluation value.

In the present example, the entire region of the input image is divided into a plurality of portions in the horizontal and vertical directions, so that a plurality of small blocks are set in the input image. Suppose now that the number of divisions in the horizontal direction and the number of divisions in the vertical direction are M and N respectively (where M and N are each an integer of 2 or more). Each small block is composed of a plurality of pixels arrayed two dimensionally. Moreover, let us introduce m and n (where m is an integer meeting 1≦m≦M and n is an integer meeting 1≦n≦N) as symbols which represent the horizontal and vertical positions of a small block in the input image. It is assumed that the larger the value of m becomes, the more rightward the horizontal position moves; and that the larger the value of n becomes, the more downward the vertical position moves. A small block whose horizontal and vertical positions are m and n respectively is represented by a small block [m, n].

Based on the main object position information output from the main object detection portion 61, the clipping region set portion 62 recognizes the center of the region (e.g., the body region) in the input image where the main object is present and checks as to the center position belongs to which small block. A point 200 in FIG. 6B represents this center. Suppose here that the center 200 belongs to a small block [m_{O}, n_{O}] (where m_{O} is an integer meeting 1≦m_{O}≦M and n_{O} is an integer meeting 1≦n_{O}≦N). Moreover, by using a known object size detection method, the small blocks are classified into small blocks where the image data of the main object appear or small blocks where the image data of the background appear. The former small blocks are called main object blocks and the latter small blocks are called background blocks.

Specifically, it is assumed that the background appears at a position sufficiently away from a point where the main object is likely to be present. And, based on image features of both points, the pixel at each point between both points is checked and classified depending on the fact the pixel belongs to the background or to the main object. The image feature includes brightness and color information of a pixel. This classification allows to estimate a target contour of the main object. And, the size of the main object is able to be estimated from the contour and, based on the estimation, the main object block and the background block are able to be sorted out from each other. Here, FIG. 6B schematically shows that the color of the main object which appears around the center 200 is different from the color of the background. Besides, a region obtained by combining all of the main object blocks with each other may be used as the main object region, while a region obtained by combining all of the background blocks with each other may be used as the background region.

For each background block, a color difference evaluation value which represents a difference between the color information of the main object and the color information of the image in the background block is calculated. Suppose that there are Q background blocks, and the color difference evaluation values calculated for the first to Q-th background blocks are represented by C_{DIS}[1] to C_{DIS}[Q] respectively (where Q is an integer meeting the inequality “2≦Q≦(M×N)−1”). For example, to calculate the color difference evaluation value C_{DIS}[1], the color signals (e.g., RGB signals) of each pixel belonging to the first background block are averaged, so that the average color of the image in the first background block is obtained; then, the position of the average color in the RGB color space is detected. On the other hand, the position, in the RGB color space, of the color information of the main object is also detected; and the distance between the two positions in the RGB color space is calculated as the color difference evaluation value C_{DIS}[1]. Thus, the larger the difference between the colors compared becomes, the larger the color difference evaluation value C_{DIS}[1] becomes. Here, it is assumed that the RGB color space is normalized such that a range of values which the color difference evaluation value C_{DIS}[1] is able to take is a range of 0 or more but 1 or less. The other color difference evaluation values C_{DIS}[2] to C_{DIS}[Q] are calculated likewise. The color space for calculating the color difference evaluation values may be another space (e.g., the HSV color space) other than the RGB color space.

Furthermore, for each background block, a position difference evaluation value which represents a spatial difference between the positions of the center 200 and of the background block on the input image is calculated. The position difference evaluation values calculated for the first to Q-th background blocks are represented by P_{DIS}[1] to P_{DIS}[Q] respectively. The position difference evaluation value of a background block is given as the distance between the center 200 and a vertex which, of the four vertices of the background block, is closest to the center 200. Suppose that a small block [1, 1] is the first background block, with 1<m_{O} and 1<n_{O}, and that, of the four vertices of the small block [1, 1], a vertex 201 is closest to the center 200, then the position difference evaluation value P_{DIS}[1] is given as the spatial distance between the center 200 and the vertex 201 on the input image. Here, it is assumed that the space region of the calculated image is normalized such that a range of values which the position difference evaluation value P_{DIS}[1] is able to take is a range of 0 or more but 1 or less. The other position difference evaluation values P_{DIS}[2] to P_{DIS}[Q] are calculated likewise.

Based on the color difference evaluation values and the position difference evaluation values obtained as described above, an integrated distance CP_{DIS} for an input image is calculated in accordance with the following formula (1). Then, by using the integrated distance CP_{DIS}, a tracking reliability evaluation value EV_{R} for an input image is calculated in accordance with the following formula (2). Specifically, if “CP_{DIS}>100,” then “EV_{R}=0”; if “CP_{DIS}≦100,” then “EV_{R}=100−CP_{DIS}.” In this calculation method, if a background of the same color as, or of a color similar to the color of the main object is present near the main object, the tracking reliability evaluation value EV_{R} becomes low.

$$\begin{matrix}{CP}_{DIS} = {\sum }_{i = 1}^{Q} \sqrt{( 1 - {C}_{DIS} ( i ) ) \times ( 1 - {P}_{DIS} ( i ) )} & ( 1 ) \\ {EV}_{R} \{ \begin{matrix}0 : & if {CP}_{DIS} > 100 \\ 100 - {CP}_{DIS} : & if {CP}_{DIS} \leq 100\end{matrix} & ( 2 )\end{matrix}$$

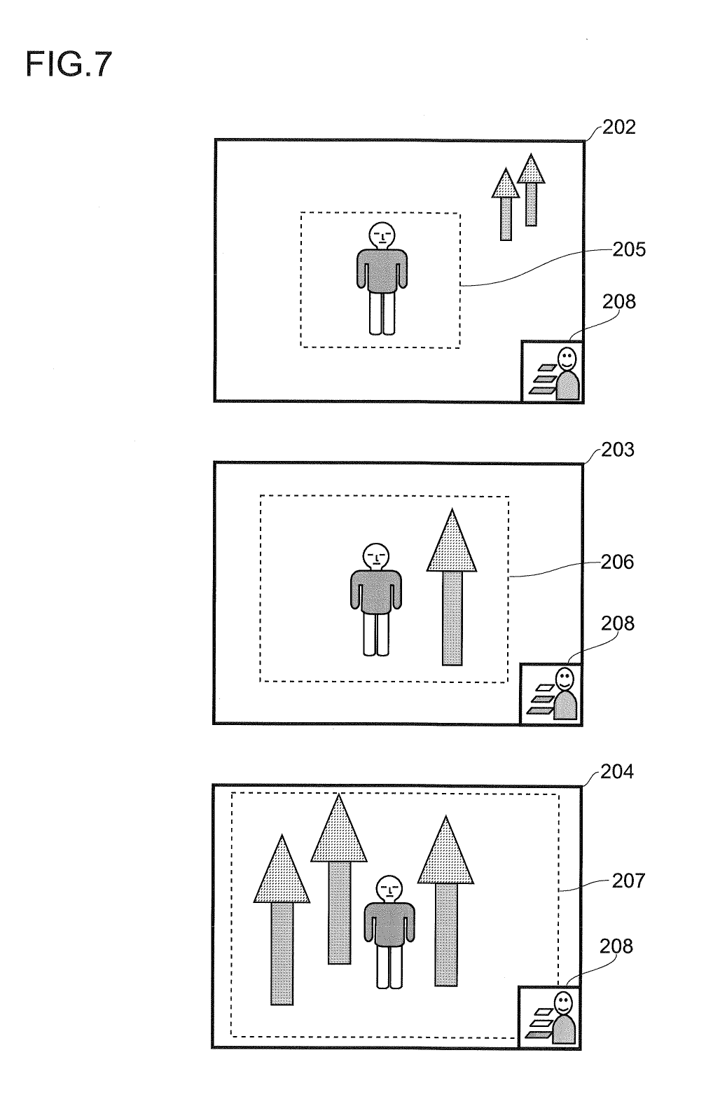

Clipping regions which the clipping region set portion 61 sets for various input images are shown in FIG. 7. In FIG. 7, the size of the main object in the input image is constant. In this example, the clipping region is set such that the higher the tracking reliability (e.g., the tracking reliability evaluation value) becomes, the smaller the size of the clipping region becomes (i.e., the enlargement factor becomes higher).

FIG. 7 shows how the clipping region is set when the tracking reliability is at a first, a second, and a third level of reliability respectively. It is assumed that, of the first, second, and third levels of reliability, the first is the highest and the third is the lowest. In FIG. 7, images 202 to 204 in the solid-line rectangular frames show each an input image in which a clipping region is to be set, and regions 205 to 207 in the broken-line rectangular frames show each a clipping region which is set for each input image. The person in each clipping region is the main object. Because a color similar to the color of the main object is located near the main object, the tracking reliability for the input images 203 and 204 is lower than that for the input image 202.

The size of the clipping region 205 set for the input image 202 is smaller than the size of the clipping region 206 set for the input image 203; and the size of the clipping region 206 is smaller than the size of the clipping region 207 set for the input image 204. The size of a clipping region is the image size of a clipping region which represents an extent of the clipping region, and is indicated by the number of pixels belonging to the clipping region.

If a clipping region is set in accordance with the method in the present example, the higher the tracking reliability is, the larger the size of the main object in the clipping region becomes. Accordingly, in a case where the main object is able to be detected accurately, it becomes possible to set a clipping region in which the area that the main object occupies is large (i.e, the main object is centered on). Besides, in a case where the main object is not able to be detected accurately, it becomes possible to prevent the main object from being located outside the clipping region.

The input images 202 to 204 shown in FIG. 7 may be displayed on the monitor during a preview or image recording. Besides, an indicator 208 which indicates a level of the tracking reliability may be contained in the input images 202 to 204 to notify the user of the level of the tracking reliability.

### Second Example

### Clipping Region Set Method

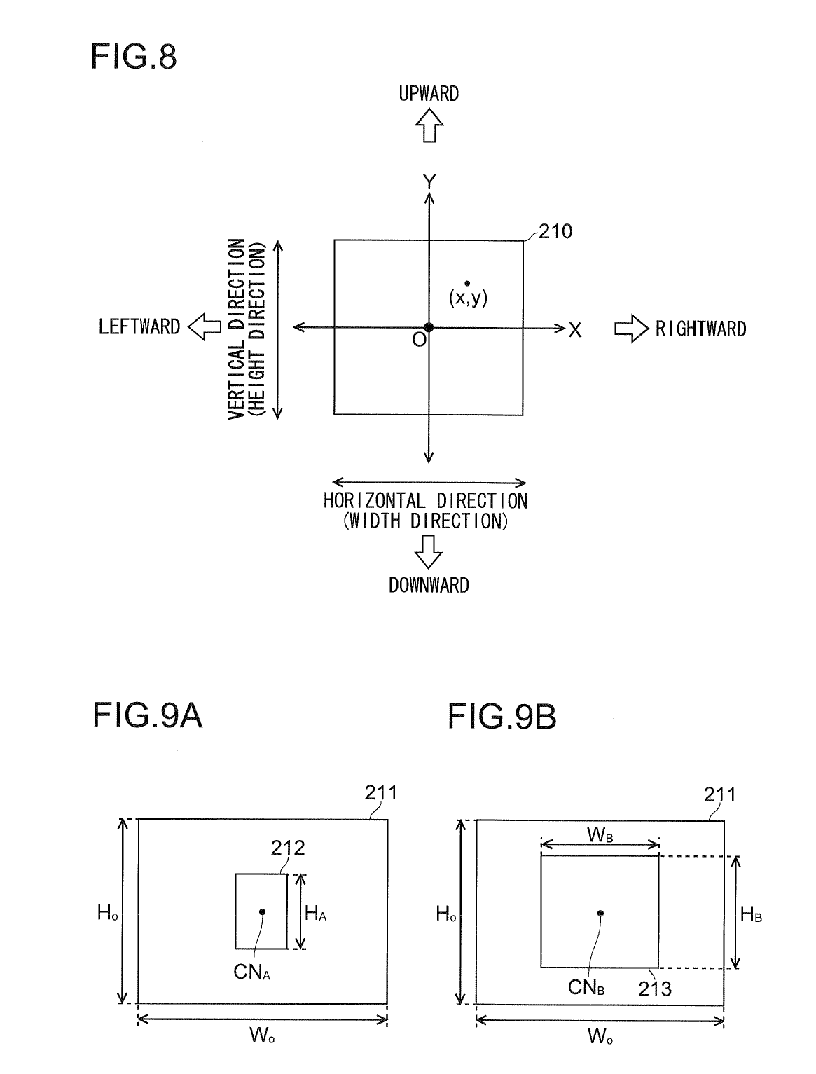

Next, a second example of the clipping region set method is described with reference to drawings. FIG. 8 is a diagram describing a coordinate of an image, and FIGS. 9A, 9B are each a diagram showing a relationship between a main object and a set clipping region. The clipping region set method in the present example sets the size of a clipping region depending on the size of a main object.

FIG. 8 shows an arbitrary image 210, such as an input image or the like, on an XY coordinate plane. It is assumed that the XY coordinate plane is a two-dimensional coordinate plane which has an X axis and a Y axis perpendicular to each other as coordinate axes; the direction in which the X axis extends is parallel to a horizontal direction of the image 210, while the direction in which the Y axis extends is parallel to a vertical direction of the image 210. Besides, in discussing an object or a region on an image, the dimension (size) of the object or region in the X-axis direction is taken as its width, and the dimension (size) of the object or region in the Y-axis direction is taken as its height. The coordinates of a point of interest on the image 210 are represented by (x, y). The symbols x and y represent the coordinates of the point of interest in the horizontal and vertical directions, respectively. The X and Y axes intersect at an origin O; and, with respect to the origin O, a positive direction of the X axis is defined as a right direction; a negative direction of the X axis is defined as a left direction; a positive direction of the Y axis is defined as an upward direction; and a negative direction of the Y axis is defined as a downward direction.

Based on the main object position information output from the main object detection portion 61, the clipping region set portion 62 calculates the size of the main object. Here, as described in the first example, it is possible to use a known object size detection method.

By using a height H_{A} of the main object, a clipping height H_{B} is calculated in accordance with a formula “H_{B}=k₁×H_{A}.” The symbol k₁ represents a previously set constant larger than 1. FIG. 9A shows an input image 211 in which the clipping region is to be set, along with a rectangular region 212 which represents a main object region in which image data of the main object are present in the input image 211. FIG. 9B shows the same input image 211 as the one shown in FIG. 9A, along with a rectangular region 213 which represents a clipping region to be set for the input image 211. The shape of the main object region is not limited to a rectangular shape and may be another shape.

The height-direction size of the rectangular region 212 (main object region) is the height H_{A} of the main object, and the height-direction size of the rectangular region 213 (clipping region) is the clipping height H_{B}. Besides, the height- and width-direction sizes of the entire region of the input image 211 are represented by H_{O} and W_{O} respectively.

By using the clipping height H_{B}, a clipping width W_{B} is calculated in accordance with a formula “W_{B}=k₂×H_{B}.” The clipping width W_{B} is the width-direction size of the rectangular region 213 (the clipping region). The symbol k₂ represents a previously set constant (e.g., k₂=16/9). If the width-direction size of the main object region is not extremely large compared with its height-direction size, the main object region is contained in the clipping region. In the present example, it is assumed that the main object is a person and the height direction of the person matches with the vertical direction of the image, and it is assumed that a main object region whose width-direction size is extremely large compared with its height-direction size is not set.

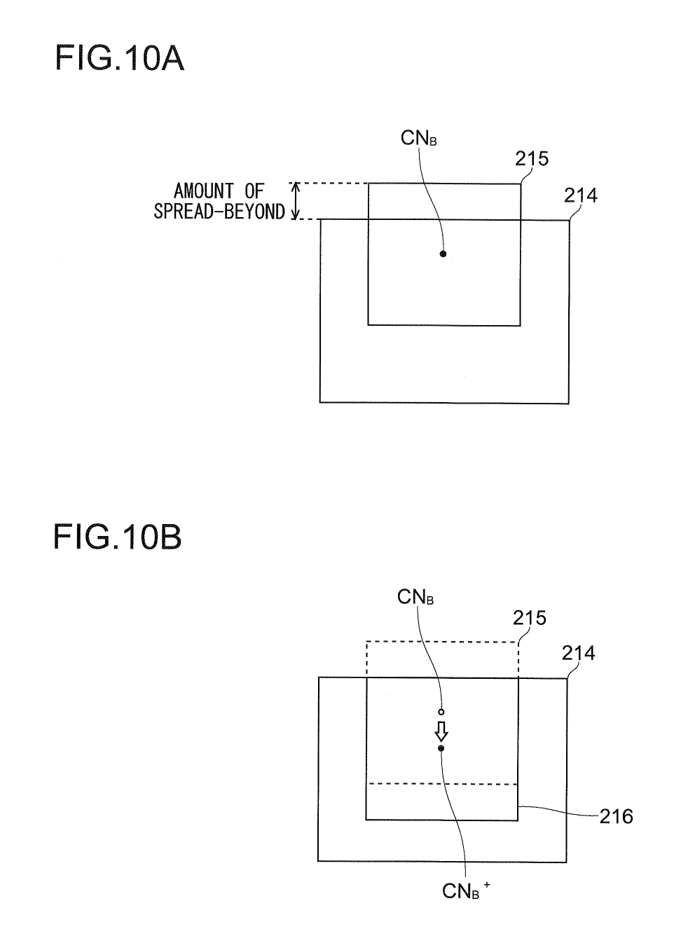

The clipping region set portion 62 obtains, from the main object position information, the coordinate values (x_{A}, y_{A}) of the center CN_{A} of the main object region, and sets the coordinate values (x_{B}, y_{B}) of the center CN_{B} of the clipping region so as to allow (x_{B}, y_{B})=(x_{A}, y_{A}). Here, the set clipping region can contain a region that spreads beyond the entire region of the input image. In this case, a position adjustment of the clipping region is performed. A specific method of the position adjustment is shown in FIGS. 10A and 10B.

For example, as shown in FIG. 10A, a case is described, in which a partial region of a clipping region 215 spreads outside the entire region of an input image 214 and upward the input image 214. Hereinafter, the partial region of the clipping region which is present outside the entire region of the input image 214 is called a spread-beyond region. Besides, the size of the spread-beyond region in the spreading direction is called the amount of spread-beyond.

If there is a spread-beyond region, a position adjustment is applied to the clipping region based on the set clipping height H_{B}, clipping width W_{B} and coordinate values (x_{B}, y_{B}); and the clipping region after the position adjustment is set as the final clipping region. Specifically, so that the amount of spread-beyond becomes exactly zero, the position adjustment is performed by correcting the coordinate values of the center CN_{B} of the clipping region. As shown in FIG. 10A, in a case where the clipping region 215 spreads upward beyond the input image 214, as shown in FIG. 10B, the center CN_{B} of the clipping region is shifted downward by the amount of spread-beyond. Specifically, if the amount of spread-beyond is Δy, a corrected y-axis coordinate value y_{B}⁺ is calculated in accordance with “y_{B}⁺=y_{B}−Δy,” and (x_{B}, y_{B}⁺) is taken as the coordinate values of the center CN_{B} of the final clipping region 216.

Likewise, in a case where the clipping region spreads downward beyond a frame image, the center CN_{B} of the clipping region is shifted upward by the amount of spread-beyond; in a case where the clipping region spreads rightward beyond the frame image, the center CN_{B} of the clipping region is shifted leftward by the amount of spread-beyond; in a case where the clipping region spreads leftward beyond the frame image, the center CN_{B} of the clipping region is shifted rightward by the amount of spread-beyond; thus, the shifted clipping region is set as the final clipping region.

Further, as a result of the downward shift of the clipping region, if the clipping region spreads downward again beyond the frame image, the size of the clipping region (the clipping height and clipping width) is corrected so as to be reduced, that is, reduction correction. Necessity of the reduction correction tends to occur when the clipping height H_{B} is relatively large.

Besides, if there is no spread-beyond region, the clipping region in accordance with the clipping height H_{B}, the clipping width W_{B}, and the coordinate values (x_{B}, y_{B}) is set as the final clipping region.

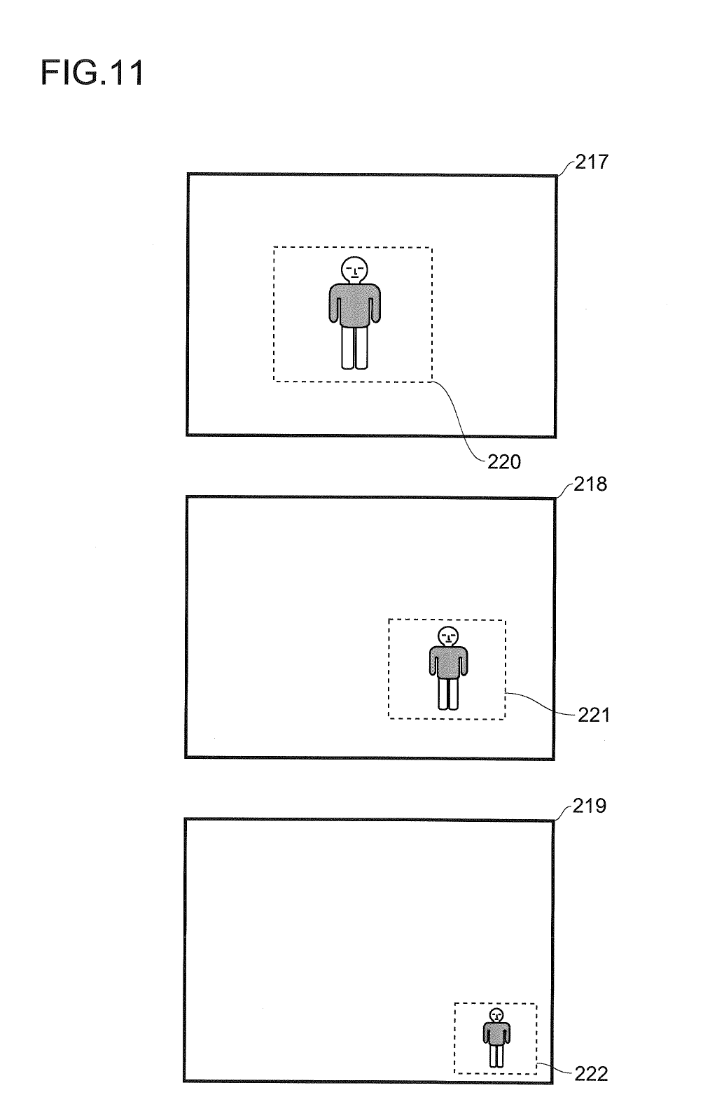

A specific example in which a clipping region is set as described above is shown in FIG. 11. FIG. 11 shows clipping regions 220 to 222 which are set for various input images 217 to 219 respectively by the clipping region set portion 62. Here, in FIG. 11, it is assumed that the main object 220 in the input image 217 is largest and the main object 22 in the input image 219 is smallest.

As shown in FIG. 11, if a clipping region is set by the method in the present example, the lager the main object is, the larger the clipping region is set; the smaller the main object is, the smaller the clipping region is set. Accordingly, it becomes possible to set the size of the main object in the clipping region so as to be substantially equal.

The present example and the first example may be combined with each other. In this case, the clipping height of the clipping region is corrected in accordance with the racking reliability evaluation value EV_{R} which represents the tracking reliability. The corrected clipping height is represented by H_{B}⁺. Specifically, by comparing the latest reliability evaluation value EV_{R} with predetermined threshold values TH₁ and TH₂, it is determined which one of the following first to third inequalities is met. The threshold values TH₁ and TH₂ are previously set so as to meet an inequality “100>TH₁>TH₂>0”; for example, TH₁=95 and TH₂=75.

If a first inequality “EV_{R}≧TH₁” is met, H_{B} is assigned to H_{B}⁺. In other words, if the first inequality is met, no correction is made to the calculated clipping height. If a second inequality “TH₁>EV_{R}≧TH₂” is met, the clipping height H_{B}⁺ is calculated to be corrected in accordance with a formula “H_{B}⁺=H_{B}×(1+((1−EV_{R}/100)/2)).” In other words, if the second inequality is met, the clipping height is corrected so as to become large. If a third inequality “TH₂>EV_{R}” is met, H_{BO} is assigned to H_{B}⁺. H_{BO} represents a constant based on a height H_{O} of the input image, the constant being, for example, equal to the height H_{O}, or slightly smaller than the height H_{O}. Also if the third inequality is met, the clipping height is corrected so as to become large.

[Zoom Information Generation Portion]

The zoom information generation portion 64 generates zoom information based on zoom intention information input from the user via the operation portion 17.

(Operation Portion and Zoom Intention Information)

For example, zoom intention information may include two kinds of information, that is, zoom-in intention information (which indicates an intention to perform zoom in) and zoom-out intention information (which indicates an intention to perform zoom out). In this case, if the operation portion 17 is equipped with a zoom-in switch and a zoom-out switch, the user's operation becomes easy, which is preferable. And, for example, during a time the user keeps pressing down the zoom-in switch (or the zoom-out switch), the zoom-in intention information (or the zoom-out intention information) may be input into the zoom information generation portion 64.

Besides, for example, the zoom intention information may not be divided into the zoom-in intention information and the zoom-out intention information. In other words, the zoom intention information may include only one kind of common zoom intention information. In this case, because the operation portion 17 needs only to have one common zoom switch, it is possible to simplify the structure. And, for example, during a time the user keeps pressing down the common zoom switch, the common zoom intention information is input into the zoom information generation portion 64.

Here, various switches are described as examples of the operation portion 17; however, a touch panel may be used. For example, by touching a predetermined region on the touch panel, the same operation as pressing down the above switch may be performed. Besides, by touching a main object or a clipping region, the zoom intention information may be input into the zoom information generation portion 64.

In addition, from a time each of the various switches or the touch panel is once pressed down or touched to a time they are pressed down or touched again, the zoom intention information may continue to be output.

(Zoom Intention Information and Zoom Information)

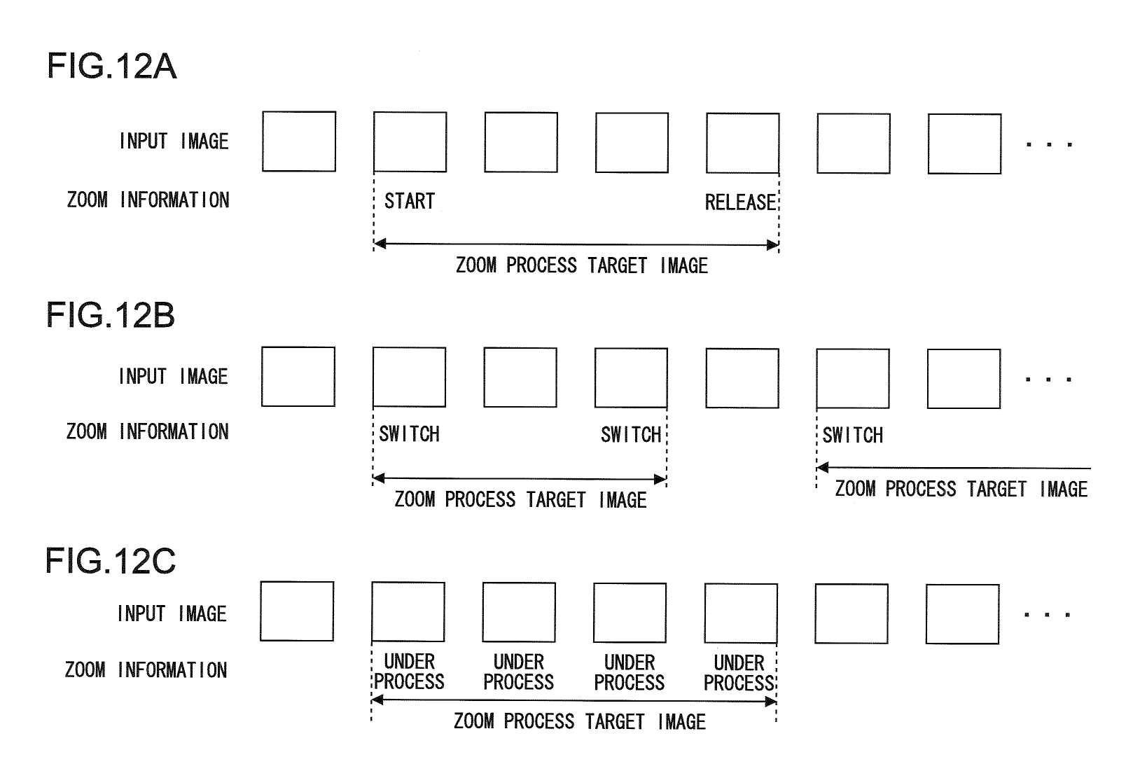

A relationship between input zoom intention information and generated zoom information is described with reference to drawings. FIGS. 12A to 12C are diagrams each showing a specific example of generated zoom information. Here, the input images shown in FIGS. 12A to 12C are newer as they go rightward. In other words, they are prepared later in a time-wise fashion.

The zoom information generation portion 64 generates zoom information based on input zoom intention information. For example, as shown in FIG. 12A, zoom start information is generated at an input start time of the zoom intention information; and zoom release information which is output at an input end time of the zoom intention information is generated. Here, for example, the input images from the input image to which the zoom start information is related to the input image to which the zoom release information is related are used as zoom process target images (images to which a zoom process is applied or which are examined whether or not to apply a zoom process to themselves at a reproduction time; details are described later).

Besides, in a case where the zoom intention information includes the zoom-in intention information and the zoom-out intention information, zoom information which discriminates these pieces of information from each other may be output. In other words, the zoom information may include four kinds of information, that is, zoom-in start information, zoom-out start information, zoom-in release information and zoom-out release information. Moreover, the zoom information may include three kinds of information, that is, the zoom-in start information, the zoom-out start information, and common zoom release information which is one piece of information formed of the zoom-in release information and zoom-out release information.

Besides, as shown in FIG. 12B, the zoom information output from the zoom information generation portion 64 may include one kind of information, that is, zoom process switch information. The zoom process switch information indicates successively the start, release, start, release, . . . , depending on the output order.

In addition, in a case where the zoom intention information includes the zoom-in intention information and the zoom-out intention information, zoom information which discriminates these pieces of information from each other may be output. In other words, the zoom information may include two kinds of information, that is, zoom-in switch information and zoom-out switch information.

Besides, as shown in FIG. 12C, the zoom information output from the zoom information generation portion 64 may include, for example, one kind of information, that is, under-zoom process information which is continuously output during a time the zoom intention information is input.

Further, in a case where the zoom intention information includes the zoom-in intention information and the zoom-out intention information, zoom information which discriminates these pieces of information from each other may be output. In other words, the zoom information may include two kinds of information, that is, under-zoom-in process information and under-zoom-out process information.

Here, the input image to which the zoom information (the zoom start information, zoom release information, zoom switch information shown in FIGS. 12A and 12B) is related may not be included in the zoom process target image. In other words, the input image inside the input image to which the zoom information is related may be the zoom process target information.

Besides, during a time of recording an input image, a notification of what kind of zoom information is recorded along with the input image may be performed for the user. For example, during a time from an output of the above zoom start information to an output of the zoom release information, or during a time the above under-zoom process information is output, the words “under-zoom process” or an icon may be displayed on the monitor. Besides, a LED (Light Emitting Diode) may be turned on or a sound may be used to notify the user.

In addition, an image in a clipping region of an input image may be displayed on the monitor; further, the input image may be displayed together with the image. And, by applying the zoom in (which narrows the clipping region) or the zoom out (which enlarges the clipping region) to the image in the clipping region and displaying the image, the effects of the zoom process applied to the clipping region may be notified for the user. The notification operation is described in detail in “image clipping adjustment portion” explained later.

Besides, the zoom information generation portion 64 may be structured so as to continuously output the under-zoom process information during a time the zoom intention information is input and to output the zoom release information at a time the input of the zoom intention information is stopped.

In addition, a structure may be employed, in which if a large motion (e.g., a motion larger than a motion which is determined to be a hand vibration) is detected in the image apparatus 1 during a time of image recording, regardless of presence of the zoom intention information, the zoom release information (especially, the zoom-in release information) is forcibly output from the zoom information generation portion 64, or the output of the under-zoom process information is forcibly stopped. According to such a structure, it becomes possible to prevent the object from going out of a region (especially, the clipping region after the zoom-in process) because of the large motion of the image apparatus 1.

(Zoom Magnification)

It is possible to include zoom magnifications (an enlargement factor and a reduction factor) in the zoom information. For example, the zoom magnification may be a predetermined value which is preset. Here, the zoom magnification may be expressed (expressed in percentage when compared with the size of the input image) with respect to the input image, or may be expressed (expressed in percentage when compared with the size of the clipping region) with respect to the clipping region.

Besides, it is possible to set the zoom magnification at a variable value other than the predetermined value. For example, a limit value (the maximum value of enlargement factors or the minimum value of reduction factors) is put on the zoom magnification, and the limit value (or a predetermined magnification vale such as a half value or the like) may be included in the zoom information. Here, the maximum value of enlargement factors may be set at a value by which the main object region 51 (see FIG. 5) is magnified to a predetermined size (e.g., the maximum size at which the display device is able to display the main object region without missing any portion). Besides, the maximum value of enlargement factors may be calculated from a limit resolution value (which is decided on in accordance with the image portion and the image process portion) which is increased when a super-resolution process later described is performed.

On the other hand, likewise, a reduction value by which the main object region 51 is reduced to a predetermined size (e.g., a size at which the main object region is able to be identified) may be used as the minimum value.

Also, an arbitrary zoom magnification which is set by the user at a time of image recording may be included in the zoom information. For example, the zoom magnification may be set depending on the time the above zoom-in switch, zoom-out switch, or common zoom switch is continuously kept pressed down. For example, the longer the press-down time is, the greater the zoom process effect may be set (the enlargement factor is set large, or the reduction factor is set small). Here, the zoom magnification set in this way may be set so as not to exceed the above limit value.

Moreover, in this case, it is preferable that as described above, the zoom process is applied to an image in a partial region (e.g., a clipping region) of the input image and the processed image is displayed on the monitor. According to such a structure, it becomes possible to notify the user of the zoom process effect. Accordingly, it becomes possible for the user to decide on a timing easily and exactly to release the zoom switch.

[Image Clipping Adjustment Portion]

As described above, the image clipping adjustment portion 63 may not be employed; however, hereinafter, a structure and operation of the clipping set portion 60 in a case where the image clipping adjustment portion 63 is employed is described.

A clipping region is set by the clipping region set portion 62 and the clipping region information is output; then, the image clipping adjustment portion 63 generates a display image based on the clipping region information and the input image. For example, an image in the clipping region is obtained from the input image and the size of the image is adjusted to obtain the display image. Here, a process to improve the image quality (e.g., resolution) may also be performed. And, for example, as described above, the generated display image is used as an image which is displayed on the monitor to notify the user of the zoom process effect.

Specifically, the image clipping adjustment portion 63 performs an interpolation process by using image data of one sheet of input image, for example. Thus, the number of pixels of the image in the clipping region is increased. As techniques of the interpolation process, various techniques such as the nearest neighbor method, bi-linear method, bi-cubic method and the like are able to be employed. Besides, an image which is obtained by applying a sharpening process to the image obtained by applying the interpolation process may be used as the display image. As the sharpening process, filtering which uses an edge enhancement filter (a differential filter or the like) or an “unsharp” mask filter may be performed. In the filtering which uses an unsharp mask filter, first, the image after the interpolation process, that is, the after-interpolation process image, is smoothed to generate a smoothed image; then, a difference image between the smoothed image and the after-interpolation process image is generated. And, the sharpening process is performed by combining the difference image and the before-sharpening process image with each other to sum up the pixel values of the difference image and the pixel values of the after-interpolation process image.

Besides, for example, a resolution increase process may be achieved by a super-resolution process which uses a plurality of input images. In the super-resolution process, a plurality of low-resolution images which are deviated in position from each other are referred to; based on the positional deviation amount between the plurality of low-resolution images and the image data of the plurality of low-resolution images, a high-resolution process is applied to the low-resolution images to generate a high-resolution image. The image clipping adjustment portion 63 is able to use a known arbitrary super-resolution process. For example, it is possible to use super-resolution processes which are disclosed in JP-A-2005-197910, JP-A-2007-205, JP-A-2007-193508 and the like. A specific example of the super-resolution process is described later.

### Modification Examples

In the above example, a case where only the electronic zoom process performed by the image process is carried out is described; however, it is possible to perform an optical zoom process together with the electronic zoom process. The optical zoom process is a process which controls the lens portion 3 to change an optical image itself that is input into the image sensor 2. Even in a case where the optical zoom process is performed, if the zoom magnification for the electronic zoom process is defined depending on a relative size and the like between the input image (or the clipping region) and the main object region, the same process is able to be performed regardless of presence of the optical zoom process. Here, a switch for the electronic zoom process and a switch for the optical zoom process may be disposed separately from each other. Besides, the optical zoom process may be prohibited during a time of recording the input image. In this case, the optical zoom process may be performed to adjust the view angle of the input image before the time immediately before the start of the recoding; and the electronic zoom process may be performed after the start of the recording

Besides, in the above example, as examples of the relevant information which is related to the input image and recorded, the clipping region information and the zoom information are described; however, information other than these pieces of information may be related to the input image as the relevant information. For example, information (the information of the face region, body region, position of the main object region and the like) which indicates the position of the main object in the input image may be related to the input image.

In addition, movement information which indicates a degree and direction of a movement of the main object may be related to the input image. It is possible to obtain the movement information of the main object from a result of the above tracking process.

Moreover, face direction information which indicates a direction of the face of the main object may be related to the input image. It is possible to obtain the face direction information by detecting the direction by means of profile samples in the above face detection process, for example.

<Clipping Process Portion>

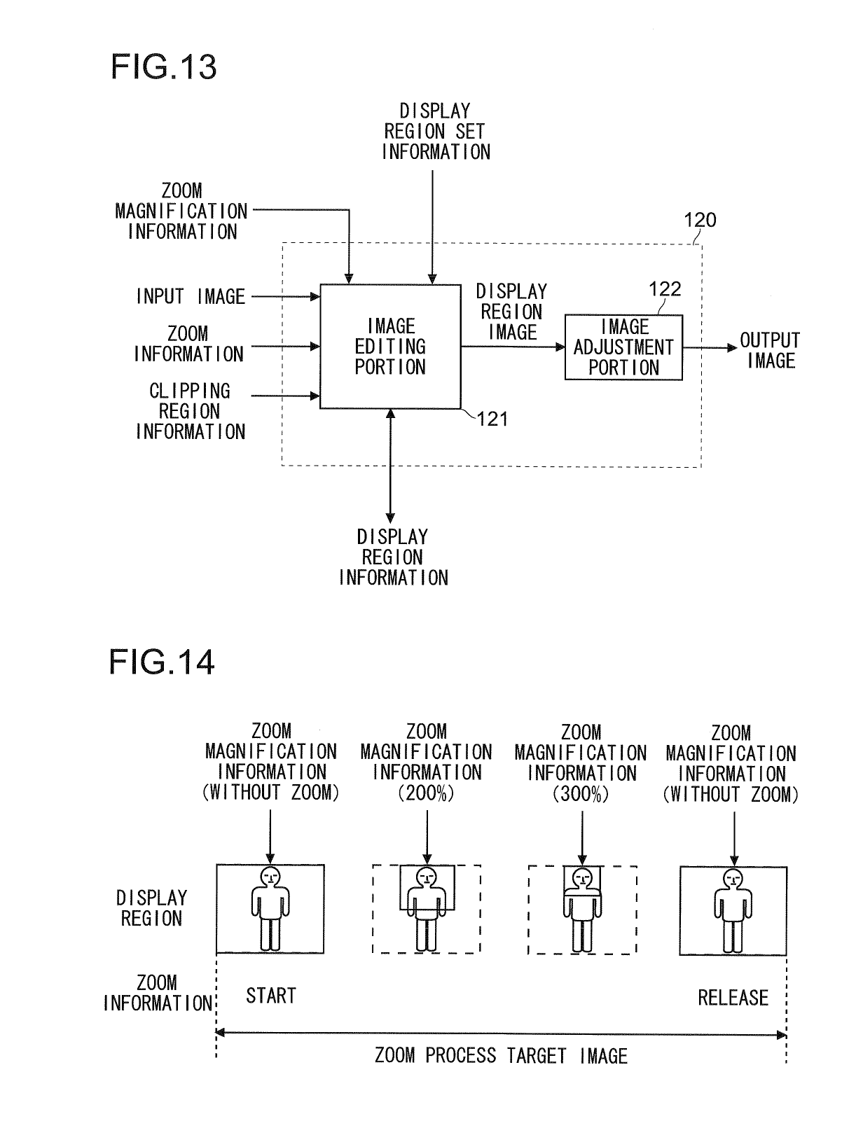

Next, the clipping process portion 120 shown in FIG. 1 is described with reference to drawings. FIG. 13 is a block diagram showing a structure of the clipping process portion. The clipping process portion 120 includes: an image editing portion 121 into which an input image, various relevant information that is generated by the clipping set portion 60 and is related to the input image, and zoom magnification information and display region set information input from the user via the operation portion 17 are input and which generates and outputs a display region image and display region information; and an image adjustment portion 122 which adjusts the display region image output from the image editing portion 121 to generate an output image.

The display region image is an image in a partial region (hereinafter, called a display region) of an input image which is set by the image editing portion 121. The display region information is information which indicates the position and size of a display region in an input image. The zoom magnification information is information which is input from a user via the operation portion 17 and indicates a zoom magnification for a clipping region (or input image). The display region set information is information which is input from a user via the operation portion 17 and specifies an arbitrary display region. The output image is an image which is displayed on the display device or monitor and input into the later-stage image output circuit portion 13.

The image editing portion 121 sets a display region for an input image, generates and outputs a display region image which is an image in the display region. In setting a display region, there is a case where a clipping region indicated by the clipping region information is used; however, there is also a case where the display region is set at an arbitrary position specified by the display region set information. Details of a method for setting a display region are described later.

The display region image output from the image editing portion 121 is converted by the image adjustment portion 122 into an image which has a predetermined size (the number of pixels), so that an output image is generated. Here, like in the above image clipping adjustment portion 63, processes such as an interpolation process, super-resolution process and the like which improve the image quality may be applied to the display region image.

Besides, recording of a display region image and an output image into the external memory 10, that is, an editing process may be performed. In a case where a display region image is recorded, to display the display region image, the recorded display region image is read into the image adjustment portion 122 to generate an output image. In a case where an output image is recorded, to display the output image, the recorded output image is read into the image output circuit portion 13.

In performing an editing process, a display region image may not be generated by the image editing portion 121 but may be recorded into the external memory 10 in the forms of the input image and display region information. Besides, the display region information may be included into a region of the header or subheader of the input image for direct relating to the input image; or a separate file of the display region information may be prepared for indirect relating to the input image. In a case where display region information is recorded, to display the display region information, the display region information is read into the image editing portion 121 together with the input image to generate a display region image. A plurality of pieces of display region information may be provided for one input image.

[Clipping Process]

First to third examples are described below as specific examples of a clipping process performed by the clipping process portion 120. A clipping process to be performed may be selected by a user from clipping processes in the examples described below.

For example, there are provided: an editing mode in which an input image is edited and the edited image and information are recorded into the external memory 10; and a reproduction mode in which an image recorded in the external memory 10 is displayed. And, if a user selects the editing mode, the clipping process in the first example is selected. On one hand, if the reproduction mode is selected, either of automatic reproduction and edited-image reproduction is further selected. If the automatic reproduction is selected, the clipping process in the second example is selected. On the other hand, the edited-image reproduction is selected, the clipping process in the third example is selected.

### First Example

### Clipping Process

The clipping process in the first example is described with reference to drawings. FIG. 14 is a diagram showing the clipping process in the first example. In the example shown in FIG. 14, in the image editing portion 121, a zoom magnification is set especially for a clipping region (a broken-line region in the drawing) of each input image, that is, a zoom process target image, so that a display region (a solid-line region in the drawing) is set. Here, the zoom magnifications shown in FIG. 14 indicate zoom magnifications for the clipping regions. A zoom magnification of 200% (300%) means that the clipping region is enlarged (zoom in) 2 times (3 times). In other words, a display region which is ½ (⅓) the size of the clipping region is set.

It is possible to check against the zoom information which is set at the time of recording an input image whether or not the input image is a zoom process target image (see FIG. 12). Besides, if a zoom magnification is included in the zoom information, this zoom magnification is able to be used as it is. Note that this zoom magnification is variable by the user and is tentatively set. Here, as the zoom magnification which is included in the zoom information and tentatively set, for example, a value (e.g., a half value) which is predetermined times as large as the limit value of the above zoom magnification or an arbitrary zoom magnification which is set by the user is able to be used.

Further, as shown in FIG. 14, based on a command (i.e., zoom magnification information) from the user, a zoom magnification is set for each input image. Here, some input images may be selected from a large number of zoom process target images as representatives; and zoom magnifications may be set for only the representatives by the user. And, a zoom magnification for an input image situated between the representative input images may be calculated by using the zoom magnifications for the representative input images. For example, a zoom magnification for an input image situated between the representative input images may be calculated by linear interpolation or non-linear interpolation.

On the other hand, the user may set the zoom magnifications for all the input images. Besides, the substantially same zoom magnification may be set for a group of input images. In addition, in a case where a sharp change occurs between the zoom magnifications (e.g, dramatically different zoom magnifications are set for successive input images), the zoom magnifications for these input images and for the input images before and after these input images may be adjusted to allow the zoom magnifications to gradually change. Moreover, the zoom magnifications may be kept as they are to still sharply change.

The zoom magnification is set as described above and thereby the display region is set. And, a display region image which is the image in the display region is recorded into the external memory 10, and an output image which is adjusted and generated by the image adjustment portion 122 is recorded into the external memory 10. Here, the display region image may not be generated by the image editing portion 121 but may be recorded into the external memory 10 in the form of the display region information. In this case, the display region information may be included into a region of the header or subheader of the input image for direct relating to the input image; or a separate file of the display region information may be prepared for indirect relating to the input image.

As described above, if a zoom magnification is set at a time of reproducing a recorded input image, it becomes possible to easily set a display region which has a desired view angle. Besides, it becomes possible to generate a display region image which has an arbitrary view angle in the input image.

In addition, if a clipping region is set as a reference region and a display region is set by setting or correcting a zoom magnification for the clipping region, the user is able to easily obtain a display region image and an output image which each have a desire view angle by only setting the zoom magnification. Here, if the set clipped region goes out of a desired region, the user is able to set the display region from the entire input image by inputting the display region set information.

In the present example, at the time of recording the input image, clipping of an image is not performed and a view angle of the output image is not decided on. Accordingly, it becomes possible to set an arbitrary display region within a view angle of the input image.

An input image may be removed from the zoom process target images; to the contrary, an input image may be added to the zoom process target images.

Besides, in a case where a display region is set in a clipping region by performing a zoom-in process (i.e., a case where the display region is formed narrower than the clipping region), the zoom-in process may be performed on the center of the clipping region, or on the main object (e.g., the face). Likewise, in a case where a display region is set beyond a clipping region by performing a zoom-out process (i.e., a case where the display region is formed larger than the clipping region), the zoom-out process may be performed centering on the center of the clipping region, or on the main object.

In addition, in a case where the user sets the zoom magnification, the input image may be displayed on the monitor or the display device, or the image in the clipping region may be displayed. Besides, the input image and the clipping region may be displayed together with each other.

### Second Example

### Clipping Process

In the present example, the image editing portion 121 automatically sets a display region. Specifically, either of an image in a clipping region (without a zoom process) and an image in a display region (a zoom process is performed) which is set with respect to a clipping region based on a zoom magnification that is set at a time of recording is output as a display region image. Here, as the zoom magnification, for example, the above limit value of the zoom magnification or an arbitrary zoom magnification set by the user is able to be used.

According to this technique, it becomes unnecessary for the user to set the zoom magnification, which makes it possible to easily display an output image.

Here, in generating an output image by the image editing portion 121 based on the obtained display region image, presence of a zoom process may be notified for the user by displaying the words “under zoom” and the like together with the output image that is obtained by the zoom process. And, a zoom magnification and a display region may be set again for an image to which the user believes that the desired zoom process is not applied.

Besides, the generated display region image and output image may be displayed and recorded into the external memory 10. In addition, the display region information may be automatically generated and recorded, that is, automatic editing may be performed.

### Third Example

### Clipping Process

In the present example, for example, the display region image generated and recorded by the operation in the first example is read from the external memory 10 into the image adjustment portion 122 to generate and output an output image. In a case where an output image is generated and recorded by the operation in the first example, the output image is read and output.

On the other hand, in a case where display region information is generated, the display region information and the input image are read from the external memory 10 into the image editing portion 121 to generate and output a display region image. And, the image adjustment portion 122 adjusts the display region image to generate and output an output image.

Besides, in a case where a plurality of pieces of display region information are set for an input image, a request may be transmitted to the user to ask for a command that shows which display region information to be used to generate a display region image and an output image.

### Display Region Set Method

### First Example

### Display Region Set Method

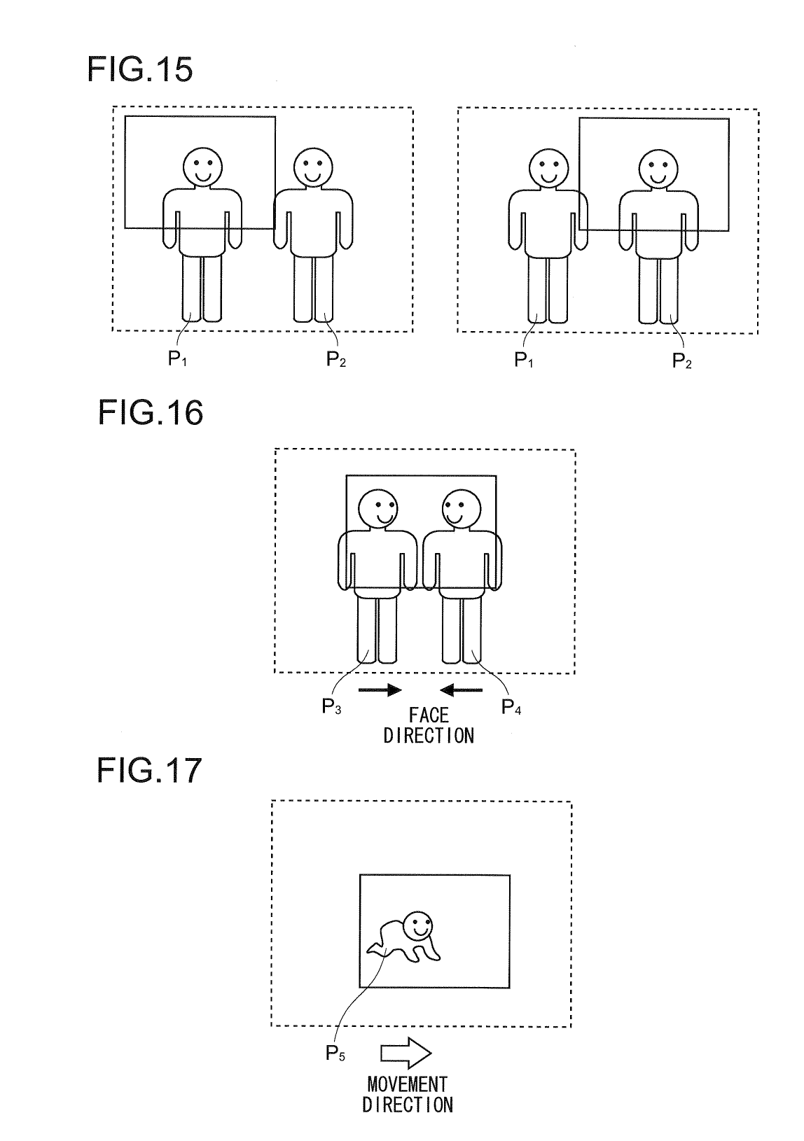

In the above example, it is described that there is one object in the input image and this object is fixed as the main object which is used as the reference to set the clipping region and the display region. In contrast, in the present example, another object may be set as the main object. The display region set method in the present example is described with reference to drawings. FIG. 15 is a diagram showing the display region set method in the first example. Besides, FIG. 15 shows that a zoom magnification is 2 times.

Especially, as shown in FIG. 15, in the present example, a display region is set at a position based on a main object. Specifically, the display region is set centering on a face region or the like of the main object. And, in the time of editing which is shown in the first example of the clipping process, not only setting of the zoom magnification but also selection (change) of an object which is used as the main object are able to be performed. As a result of this, for example, in a left drawing in FIG. 15, a left object P₁ is able to be used as a main object, and at the same time, in a right drawing in FIG. 15, a right object P₂ is able to be used as a main object.

As described above, because selection (change) of a main object is possible, it becomes possible to change a view angle of an output image depending on switching of the main object. Accordingly, it is possible to obtain an output image the view angle of which is able to be switched to draw attention to an arbitrary object.

Note that a case where the main object is selected from the objects in the clipping region is described; however, an object outside the clipping region may be selected as long as the object is present in the input image. In this case, as described above, the display region may be set outside the clipping region. Besides, the main object is not limited to only a person. For example, the main object may be an animal or the like.

### Second Example

### Display Region Set Method

In the present example, a display region having a view angle which confines a plurality of objects is set. The display region set method in the present example is described with reference to drawings. FIG. 16 is a diagram showing the display region set method in the second example. Besides, FIG. 16 shows that a zoom magnification is 2 times.

As shown in FIG. 16, in the present example, if a main object P₃ and an object P₄ face each other, a display region which confines the main object P₃ and the object P₄ is set. Here, by using the above face direction information, directions of the faces of the main object P₃ and the object P4 are detected. The face direction information of all the objects may be obtained and related to the input image. Besides, only the face direction information of the main object and of a nearby object may be obtained and related to the input image.

According to this technique, it becomes possible to confine a plurality of objects which face each other to have a dialog within the view angle of an output image. Accordingly, it becomes possible to obtain an output image which clearly represents a motion of the main object.

Note that the present example may be performed in the time of editing shown in the first operation example of the clipping process portion 120, or may be performed in the time of automatic reproduction (editing) shown in the second example. In a case where the present example is performed in the time of automatic reproduction (editing), for example, if there is an object which faces the main object, the display region set method in the present example is performed.

Besides, it is described that the present example is used to set a display region by the image editing portion 121; however, the present example may be used to set a clipping region by the clipping region set portion 62.

### Third Example

### Display Region Set Method

In the present example, a display region depending on a movement of an object is set. The display region set method in the present example is described with reference to drawings. FIG. 17 is a diagram showing the display region set method in the third example. Besides, FIG. 17 shows that a zoom magnification is 2 times.

As shown in FIG. 17, in the present example, a display region is set so as to allow the position of a main object P₅ in a display region to be situated in an opposite side with respect to a movement direction of the main object P₅. In other words, the display region is set so as to allow a region in the movement-direction side of the main object P₅ to become large. Specifically, in FIG. 17, the movement direction of the main object P₅ is a right direction. Accordingly, the display region is set so as to allow the position of the main object P₅ to come left. Accordingly, the display region is set so as to allow the region to the right of the main object P₅ to become large and the region to the left of the main object P₅ to become small.

According to this technique, an output image is displayed with the region in the movement-direction side of the main object focused on. If the main object is a moving thing, there is often an object ahead of the moving thing. Accordingly, by setting a display region whose front region in the movement direction is large, it becomes possible to obtain an output image which clearly represents a state of the main object.

Note that the present example may be performed in the time of editing shown in the first example of the clipping process, or may be performed in the time of automatic reproduction (editing) shown in the second example. In a case where the present example is performed in the time of automatic reproduction (editing), for example, if a movement of the main object larger than a predetermined movement occurs, the display region set method in the present example is performed.

Besides, it is described that the present example is used to set a display region by the image editing portion 121; however, the present example may be used to set a clipping region by the clipping region set portion 62.

### Modification Example

It is possible to perform a combination of the first to third examples of the display region set method. For example, the main objects set in the second example and third example may be changeable as described in the first example. Besides, by combining the second and third examples with each other, a display region which contains a plurality of objects and whose front region in a movement-direction side is large may be set for the plurality of objects which move facing each other

### Other Examples

The above clipping set portion 60 and the clipping process portion 120 relate the relevant information such as clipping region information, zoom information and the like to an input image having a large view angle and record the relevant information; set a display region for the input image at a time of reproduction or editing; and generate a display region image and an output image. However, the present invention is not limited to this example.

For example, at a time of recording, a clipped image which is an image in a clipping region may be generated and recoded into the external memory 10. In this case, at a time of reproduction or editing, a display region is set and clipped for the clipped image and an output image is generated. In other words, in the present example, the clipped image processed by the reproduction image process portion 12 corresponds to the input image in the above example. Accordingly, the clipping process portion 120 directly sets the display region for the input image (the clipped image in the present example). Here, the display region is set based on the zoom magnification information which is related to the input image (the clipped image in the present example) or input from the user.

According to this technique, the zoom process is applied to a clipped image whose data amount is small. Accordingly, it becomes possible to reduce the time required for various image processes compared with the case where the above input image is used.

However, it becomes impossible to set a display region beyond a clipping region. Especially it becomes impossible to perform a zoom process (to set a display region beyond a clipping region). Accordingly, the degree of freedom to select a view angle becomes lower than that in the above examples. However, it becomes possible to make the degree of freedom to select a view angle higher than that in the case where an after-zoom view angle is set at a time of recording an image (a display region is set at a time of recording).

Besides, the present invention is applicable to an image apparatus for a dual codec system described below. Here, the dual codec system is a system which is able to perform two compression processes. In other words, two compressed images are obtained from one input image which is obtained by imaging. Besides, more than two compressed images may be obtained.

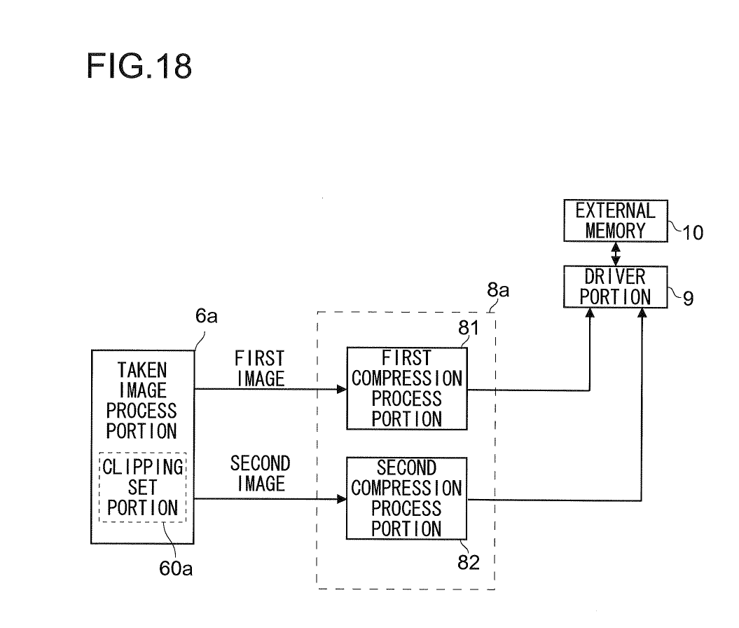

FIG. 18 is a block diagram showing a basic portion of an image apparatus which includes a dual codec system. Especially, structures of a taken image process portion 6a, a compression process portion 8a and other portions around them are shown. Note that structures of not-shown portions may be the same as those in the image apparatus 1 shown in FIG. 1. Besides, portions which have the same structures as those in FIG. 1 are indicated by the same reference numbers and detailed description of them is skipped.

The image apparatus (basic portion) shown in FIG. 18 includes: the taken image process portion 6a which processes a taken image to output a first image and a second image; the compression process portion 8a which compresses the first image and the second image output from the taken image process portion 6a; the external memory 10 which records the compressed and coded first and second images that are output from the compression process portion 8a; and the driver portion 9.

Besides, the taken image process portion 6a includes a clipping set portion 60a. The compression process portion 8a includes a first compression process portion 81 which applies a compression process to the first image and a second compression process portion 82 which applies a compression process to the second image.

And, the taken image process portion 6a outputs the two images of the first image and the second image. Here, like the above clipping set portion 60 (see FIGS. 1 and 2), the clipping set portion 60a generates and outputs various relevant information which is used to perform a clipping process by the later-stage clipping process portion 120 (see FIGS. 1 and 13). The relevant information may be related to either of the first image and the second image, or may be related to both of them. Besides, an image for which a display region is set by the clipping process portion 120 may be used as either of the first image and the second image, or may be used as both of them.

The first image is compressed by the first compression process portion 81. On the other hand, the second image is compressed by the second compression process portion 82. Here, a compression process method used by the first compression process portion 81 is different from a compression process method used by the second compression process portion 82. For example, the compression process method used by the first compression process portion 81 may be H.264, while the compression process method used by the second compression process portion 82 may be MPEG2.

Here, the first image and the second image may be total-view-angle images (input image), or may be an image (a clipped image) having a partial view angle of the total view angle. To use at least one of the first image and the second image as a clipped image, the clipping set portion 60a performs a clipping process to generate the clipped image. Besides, to use at least one of the first image and the second image as a clipped image, the later-stage clipping process portion 120 may set a display region for the clipped image as described above.

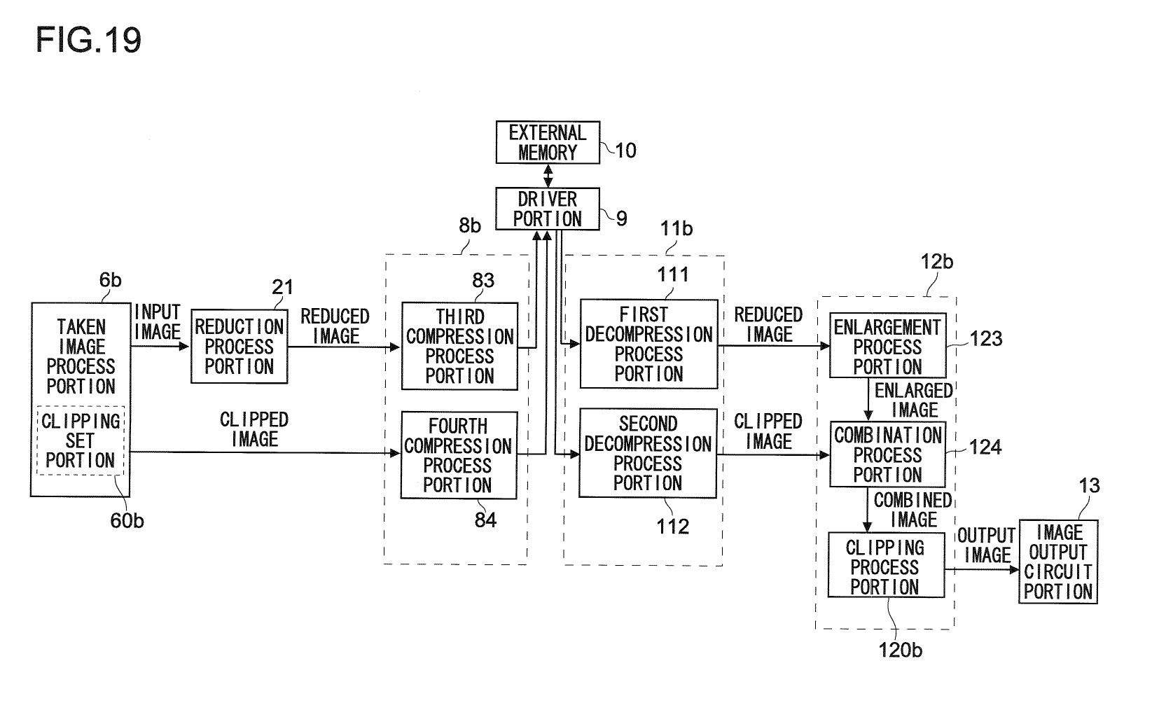

Next, another example of an image apparatus which includes a dual codec system is described with reference to drawings. FIG. 19 is a block diagram showing a basic portion of an image apparatus which includes a dual codec system. Especially, structures of a taken image process portion 6b, a compression process portion 8b, an reproduction image process portion 12b and other portions around them are shown. Note that structures of not-shown portions may be the same as those in the image apparatus 1 shown in FIG. 1. Besides, portions which have the same structures as those in FIG. 1 are indicated by the same reference numbers and detailed description of them is skipped.

The image apparatus (basic portion) shown in FIG. 19 includes: the taken image process portion 6b which processes a taken image to output an input image and a clipped image; a reduction process portion 21 which reduces the input image output from the taken image process portion 6b to produce a reduced image; the compression process portion 8b which compresses the reduced image and the clipped image; the external memory 10 which records the compressed-and-coded reduced image and clipped image output from the compression process portion 8b; the driver portion 9; a decompression process portion 11b which decompresses the compressed-and-coded reduced image and clipped image read from the external memory 10; the reproduction image process portion 12b which generates an output mage based on the reduced image and clipped image output from the decompression process portion 11b; and the image output circuit portion 13.

Besides, the taken image process portion includes a clipping set portion 60b. The compression process portion 8b includes: a third compression process portion 83 which applies a compression process to a reduced image; and a fourth compression process portion 84 which applies a compression process to a clipped image. The decompression process portion 11b includes: a first decompression process portion 111 which decompresses a compressed-and-coded reduced image; and a second decompression process portion 112 which decompresses a compressed-and-coded clipped image. The reproduction image process portion 12b includes: an enlargement process portion 123 which enlarges the reduced image output from the first decompression process portion 111 to generate an enlarged image; a combination process portion 124 which combines the enlarged image output from the enlargement process portion 123 and the clipped image output from the second decompression process portion 112 with each other to generate a combined image; and a clipping process portion 120b which sets a display region for the combined image output from the combination process portion 124 to generate an output image.

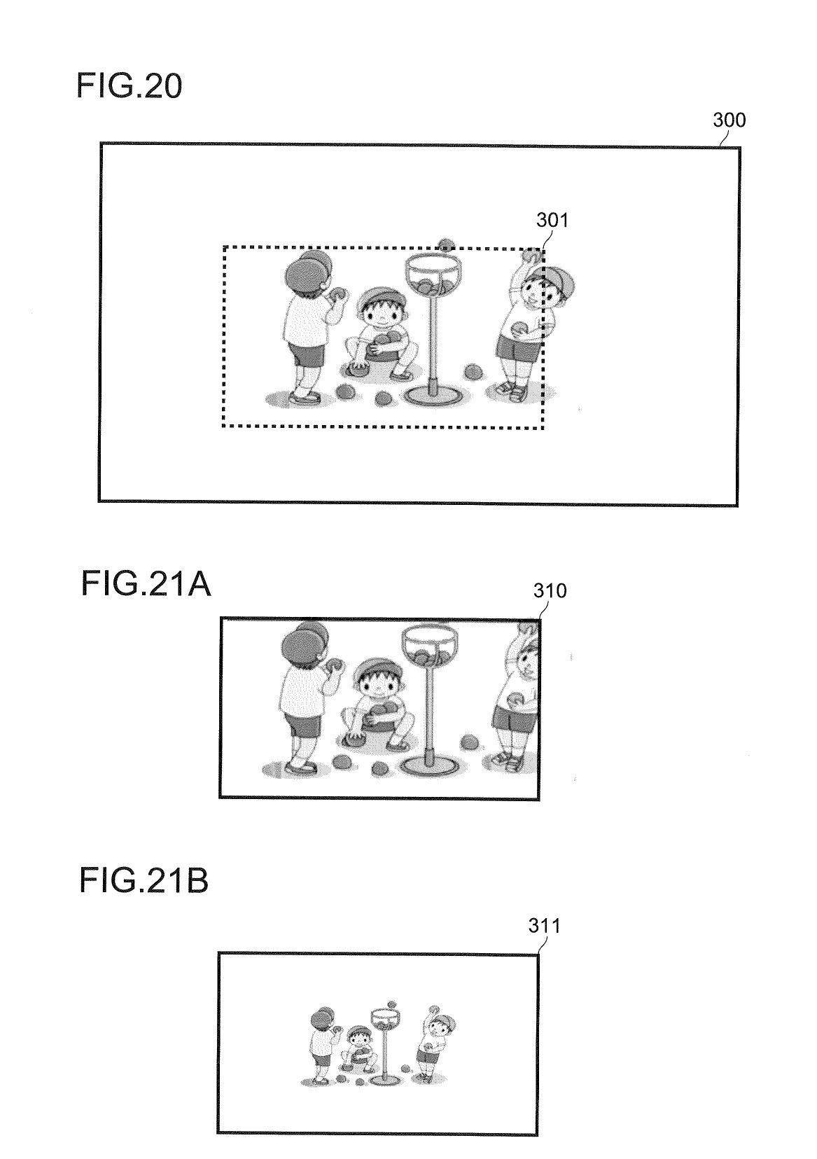

Operation of the image apparatus in the present example is described with reference to drawings. FIG. 20 is a diagram showing examples of an input image and a clipping region which is set. As shown in FIG. 20, the clipping set portion 60b sets a clipping region 301 for an input image 300. In the present example, if the size of the clipping region 301 is made constant (e.g., ½ the input image), the later-stage processes are standardized, which is preferable.

FIG. 21 is a diagram showing examples of a clipped image and a reduced image. FIG. 21A shows a clipped image 310 obtained from the input image 300 shown in FIG. 20; FIG. 21B shows a reduced image 311 obtained from the same input image 300. In the present example, the clipping set portion 60b not only sets the clipping region 301 but also performs a clipping process to generate the clipped image 310. The reduction process portion 21 reduces the input image 301 to generate the reduced image 311. Here, the number of pixels is reduced by performing a pixel addition process and a thin-out process, for example. Even if a reduction process is applied to the input image, the view angle is still maintained at the total view angle before the process.

The reduced image and the clipped image are respectively compressed by the third compression process portion 83 of the compression process portion 8b and by the fourth compression process portion 84 of the compression process portion 8b and recorded into the external memory 10. And, the compressed reduced image and the compressed clipped image are read into the decompression process portion 11b and decompressed, then the reduced image is output from the first decompression process portion 111 and the clipped image is output from the second decompression process portion 112.

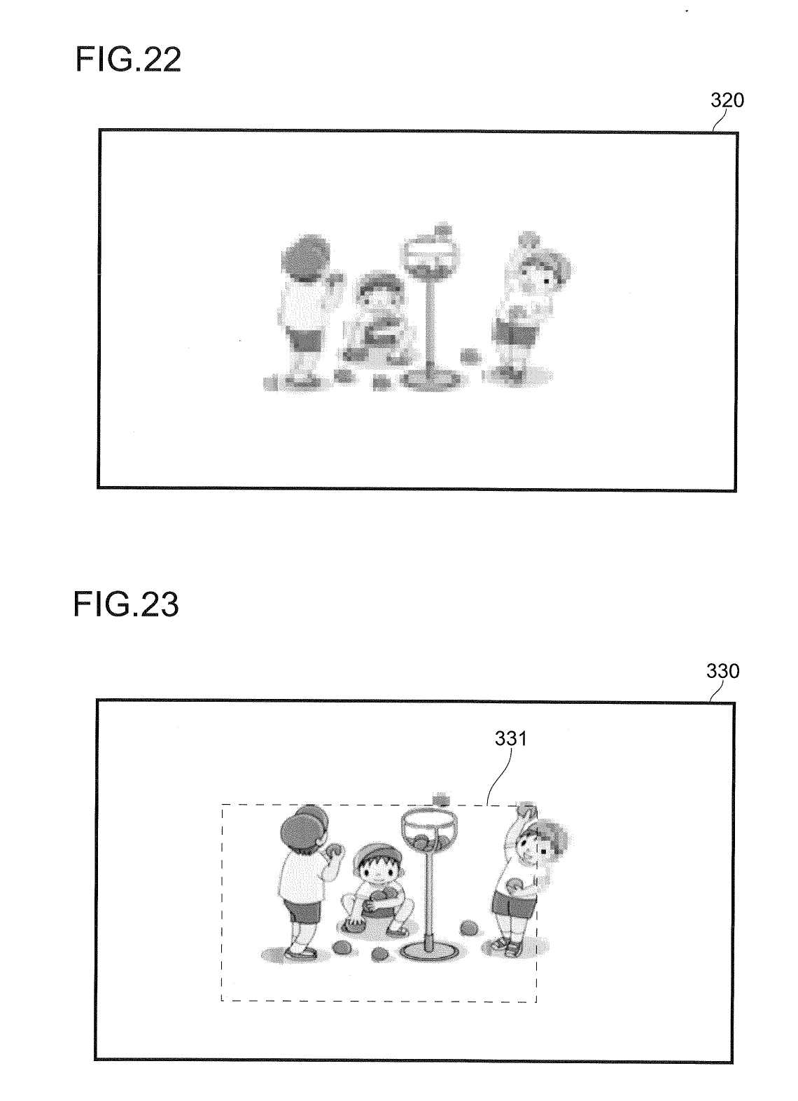

The reduced image is input into the enlargement process portion 123 of the reproduction image process portion 12b to be enlarged, so that an enlarged image 320 is generated as shown in FIG. 22, for example. FIG. 22 is a diagram showing an example of an enlarged image, and shows the enlarged image 320 which is obtained by enlarging the reduced image 311 shown in FIG. 21B. The enlargement process portion 123 increases the number of pixels of the reduced image 311 to enlarge the reduced image 311 by using, for example, a between-pixels interpolation process (e.g., nearest neighbor interpolation, bi-linear interpolation, bi-cubic interpolation and the like), a super-resolution process and the like. Here, FIG. 22 shows an example of the enlarged image 320 in a case where the reduced image 311 is enlarged to the same size as that of the input image 301 by a simple interpolation process. Accordingly, the image quality of the enlarged image 320 is worse than the image quality of the input image 301.

The enlarged image output from the enlargement process portion 123 and the clipped image output from the second decompression process portion 112 are input into the combination process portion 124 of the reproduction image process portion 12b and combined with each other, so that a combined image 330 is generated as shown in FIG. 23. FIG. 23 is a diagram showing an example of a combined image, and here shows the combined image 330 which is obtained by combining the clipped image 310 shown in FIG. 21A with the enlarged image 320 shown in FIG. 22. Here, a region 331 combined with the clipped image 310 is shown by a broken line. Besides, as shown in FIG. 23, the image quality (i.e., the image quality of the input image 300) of the region 331 combined with the clipped image is better than the image quality (i.e., the image quality of the enlarged image 320) of the surrounding region. In addition, the view angle of the combined image 330 is substantially equal to the view angle (total angle) of the input image 300.

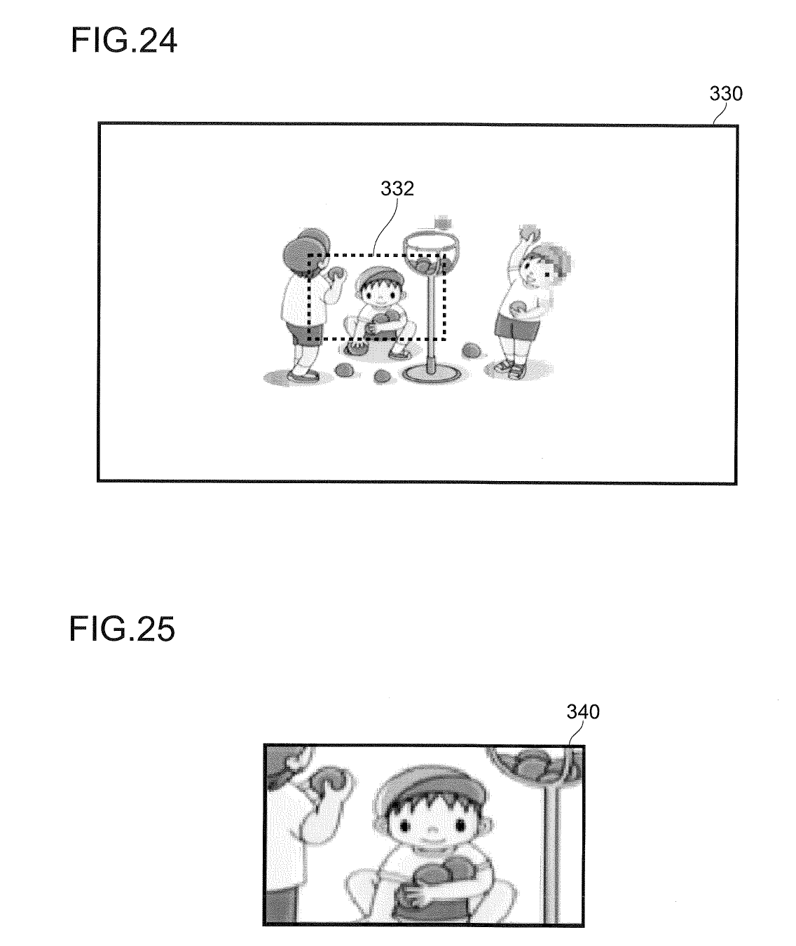

The clipping process portion 120b sets a display region 322, for example, as shown in FIG. 24, for the input image 330 obtained as described above and performs a clipping process to generate a display region image. FIG. 24 is a diagram showing examples of a combined image and a display region that is set, and here shows a case where the display region 332 is set in the combined image 330.

And, the clipping process portion 120b adjusts the display region image to generate an output image 340 as shown in FIG. 25, for example. FIG. 25 is a diagram showing an example of an output image, and here shows the output image 340 which is obtained from the image (display region image) in the display region 332 shown in FIG. 24.

In the image apparatus including a dual codec system in the present example, it becomes possible to set the display region 332 in the combined image 330 which has the view angle (total view angle) substantially equal to the view angle of the input image 300. Accordingly, it becomes possible to set the display region 332 beyond the clipping region 301 (the region 331 combined with the clipping region). Especially, it becomes possible to perform a zoom-out process (to set a display region larger than a clipping region).

Moreover, an image to be recorded becomes a reduced image which is obtained by reducing an input image and becomes a clipped image which is obtained by clipping part of the input image. Accordingly, it becomes possible to not only reduce the data amount of the image to be recorded but also speed up the process. Besides, it is possible to improve the image quality of a region combined with a clipped image in a combined image to which a zoom-in process is highly likely to be applied because a main object is contained.

In the above example, a display region is set in a combined image; however, a display region may be set in an enlarged image, or may be set in a clipped image. Note that in a case where a display region is set in a clipped image, it is impossible to set the display region beyond the area of the clipped image as described above.

<Super-Resolution Process>

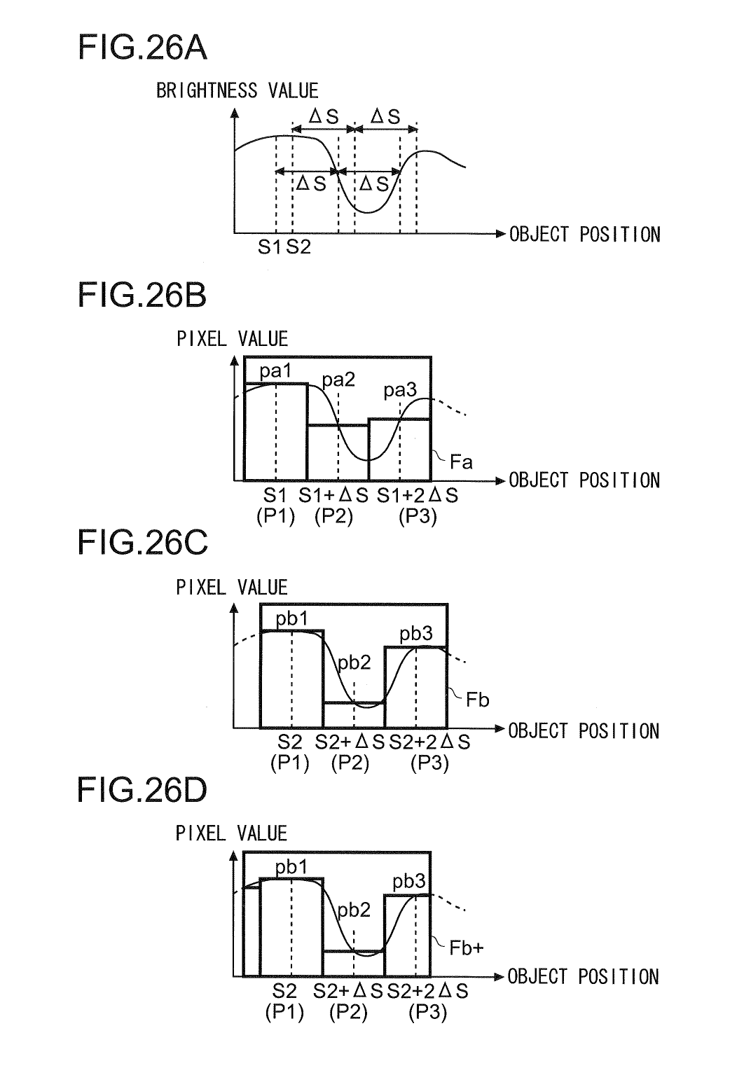

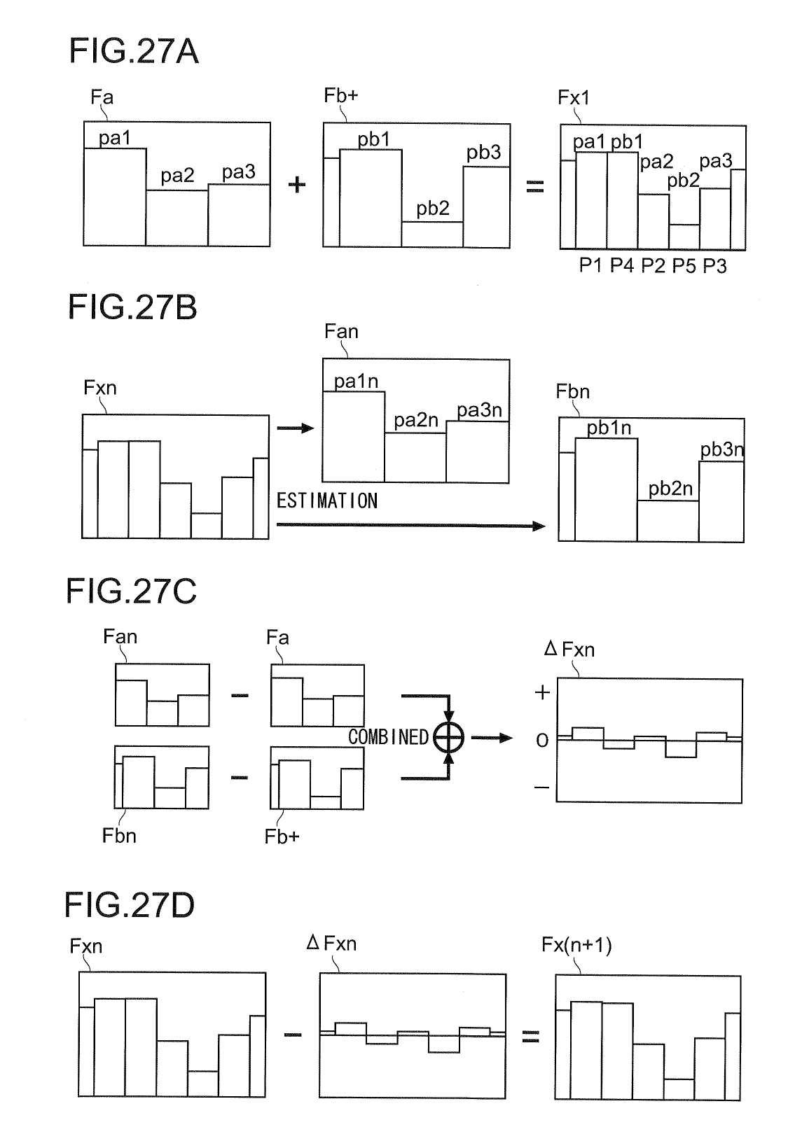

A specific example of the above super-resolution process is described. Hereinafter, a MAP (Maximum A Posterior) method which is a kind of super-resolution process is used as an example and described with reference to drawings. FIGS. 26, 27 show schemas of the super-resolution process.

In the following description, for simple description, a plurality of pixels arranged in one direction in an image which is a process target are discussed. Besides, a case where two images are combined with each other to generate an image and pixel values to be combined are brightness values is described as an example.

FIG. 26A shows brightness distribution of an object whose image is to be taken. FIGS. 26B and 26C each show brightness distribution of an image obtained by taking an image of the object shown in FIG. 26A. Besides, FIG. 26D shows an image obtained by shifting the image shown in FIG. 26C by a predetermined amount. Note that the image shown in FIG. 26B (hereinafter, called a low-resolution raw image Fa) and the image shown in FIG. 26C (hereinafter, called a low-resolution raw image Fb) are taken at different times.

As shown in FIG. 26B, the positions of sample points of the low-resolution raw image Fa obtained by imaging, at a time T1, the object which has the brightness distribution shown in FIG. 26A are indicated by S1, S1+ΔS, and S1+2ΔS. Besides, as shown in FIG. 26C, the positions of sample points of the low-resolution raw image Fb obtained by imaging the object at a time T2 (T1≠T2) are indicated by S2, S2+ΔS, and S2+2ΔS. Here, it is assumed that the sample point S1 of the low-resolution raw image Fa and the sample point S2 of the low-resolution raw image Fb are deviated from each other because of hand vibration or the like. In other words, the pixel positions are deviated from each other only by (S1−S2).

In the low-resolution raw image Fa shown in FIG. 26B, brightness values obtained at the sample points S1, S1+ΔS and S1+2ΔS are indicated by pixel values pa1, pa2 and pa3 at pixels P1, P2 and P3. Likewise, in the low-resolution raw image Fb shown in FIG. 26C, brightness values obtained at the sample points S2, S2+ΔS and S2+2ΔS are indicated by pixel values pb1, pb2 and pb3 at pixels P1, P2 and P3.

Here, in a case where the low-resolution raw image Fb is represented with respect to the pixels P1, P2 and P3 (the image of interest) of the low-resolution raw image Fa (in other words, a case where the position the low-resolution raw image Fb is corrected, that is, positional deviation-corrected, only by the movement amount (S1−S2) with respect to the low-resolution raw image Fa), a low-resolution raw image Fb+after the positional deviation correction is shown in FIG. 26D.

Next, a method for generating a high-resolution image by combining the low-resolution raw image Fa and the low-resolution raw image Fb+ with each other is shown in FIG. 27. First, as shown in FIG. 27A, the low-resolution raw image Fa and the low-resolution raw image Fb+ are combined with each other, and thus a high-resolution image Fx1 is estimated. Here, for simple description, for example, it is assumed that the resolution is doubled in one direction. Specifically, the pixels of the high-resolution image Fx1 are assumed to include the pixels P1, P2 and P3 of the low-resolution raw images Fa and Fb+, the pixel P4 located at the middle point between the pixels P1 and P2 and the pixel P5 located at the middle point between the pixels P2 and P3.

As a pixel value of the pixel P4 in the low-resolution raw image Fa, a pixel value pb1 is selected because the distance from the pixel positions (the center of the pixels) of the pixels P1, P2 to the pixel position of the Pixel 4 in the low-resolution raw image Fa is shorter than the distance from the pixel position of the pixel P1 to the pixel position of the pixel P4 in the low-resolution raw image Fb+. Likewise, as a pixel value of the pixel P5, a pixel value pb2 is selected because the distance from the pixel positions of the pixel P2, P3 to the pixel position of the pixel P5 in the low-resolution raw image Fa is shorter than the distance from the pixel positions of the pixel P2 to the pixel position of the pixel P5 in the low-resolution raw image Fb+.

Thereafter, as shown in FIG. 27B, the obtained high-resolution image Fx1 is subjected to calculation using a conversion formula including, as parameters, the amount of down sampling, the amount of blur and the amount of positional deviation (which corresponds to the amount of movement), so that low-resolution estimated images Fa1 and Fb1 which are estimated images corresponding respectively to the low-resolution raw images Fa and Fb are generated. Here, FIG. 27B shows low-resolution estimated images Fan and Fbn which are generated from a high-resolution image Fxn that is estimated by an n-th process.

For example, when n=1, based on the high-resolution image Fx1 shown in FIG. 27A, the pixel values at the sample points S1, S1+ΔS and S1+2ΔS are estimated, and the low-resolution estimated image Fa1 which has the obtained pixel values pall to pa31 as the pixel values of the pixels P1 to P3 is generated. Likewise, based on the high-resolution image Fx1, the pixel values at the sample points S2, S2+ΔS and S2+2ΔS are estimated, and the low-resolution estimated image Fb1 which has the obtained pixel values pb11 to pb31 as the pixel values of the pixels P1 to P3 is generated. Then, as shown in FIG. 27C, a difference between the low-resolution estimated images Fa1 and Fb1 and a difference between the low-resolution raw images Fa and Fb are obtained; and these differences are combined with each other to obtain a difference image ΔFx1 for the high-resolution image Fx1. Here, FIG. 27C shows a difference image ΔFxn for a high-resolution image Fxn which is obtained by an n-th process.

For example, in a difference image ΔFa1, difference values (pa11−pa1), (pa21−pa2) and (pa31−pa3) become pixel values of the pixels P1 to P3; and in a difference image ΔFb1, difference values (pb11−ph1), (pb21−pb2) and (pb31−pb3) become pixel values of the pixels P1 to P3. And, by combining the pixel values of the difference images ΔFa1 and ΔFb1 with each other, difference values at the pixels P1 to P5 are calculated, so that the difference image ΔFx1 is obtained for the high-resolution image Fx1. To obtain the difference image ΔFx1 by combining the pixel values of the difference images ΔFa1 and ΔFb1 with each other, in case where an ML (Maximum Likelihood) method or a MAP method is used, a squared error is used as an evaluation function. Specifically, a value obtained by squaring each pixel value in each of the difference images ΔFa1 and ΔFb1 and adding the squared pixel values between frames is used as the evaluation function. The gradient which is a differential value of this evaluation function is a value that is two times as large as the pixel values of the difference images ΔFa1 and ΔFb1. Accordingly, the difference image ΔFx1 for the high-resolution image Fx1 is calculated by performing a high-resolution process which uses values obtained by doubling the pixel value of each of the difference images ΔFa1 and ΔFb1.

Thereafter, as shown in FIG. 27D, the pixel values (difference values) of the pixels P1 to P5 in the obtained difference image ΔFx1 are subtracted from the pixel values of the pixels P1 to P5 in the high-resolution image Fx1, so that a high-resolution image Fx2 which has pixel values close to the object having the brightness distribution shown in FIG. 26A is rebuilt. Here, FIG. 27D shows a high-resolution image Fx(n+1) obtained by an n-th process.

The series of processes described above are repeated, so that the pixel values of the obtained difference image ΔFxn decrease and thus the pixel values of the high-resolution image Fxn converge to pixel values close to the object having the brightness distribution shown in FIG. 26A. And, when the pixel values (difference values) of the difference image ΔFxn become lower than a predetermined value, or when the pixel values (difference values) of the difference image ΔFxn converge, the high-resolution image Fxn obtained by the previous process (the (n−1)-th process) becomes an image after the super-resolution process.

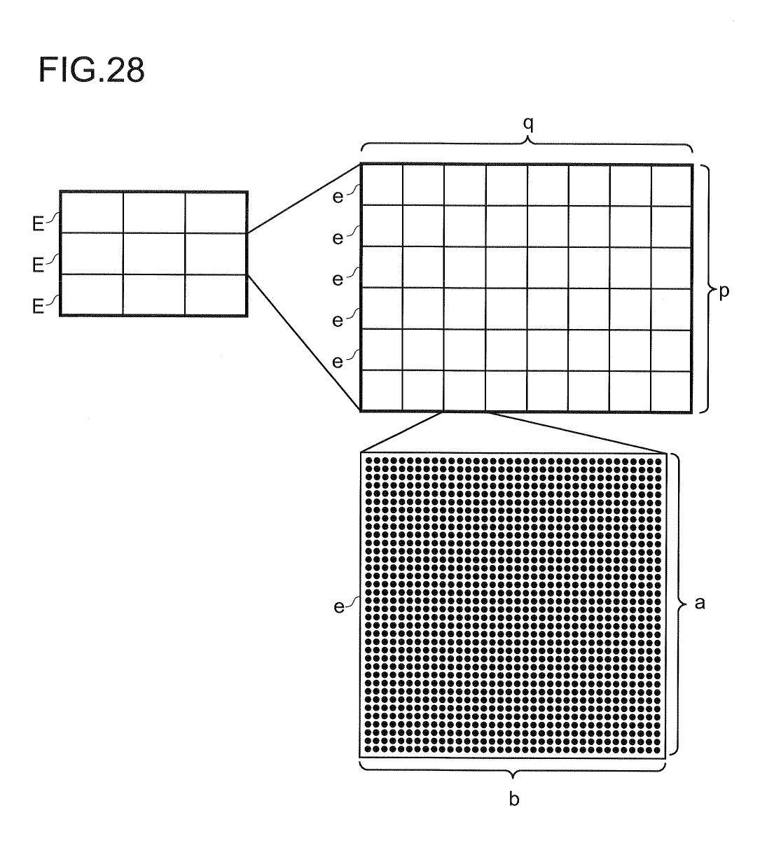

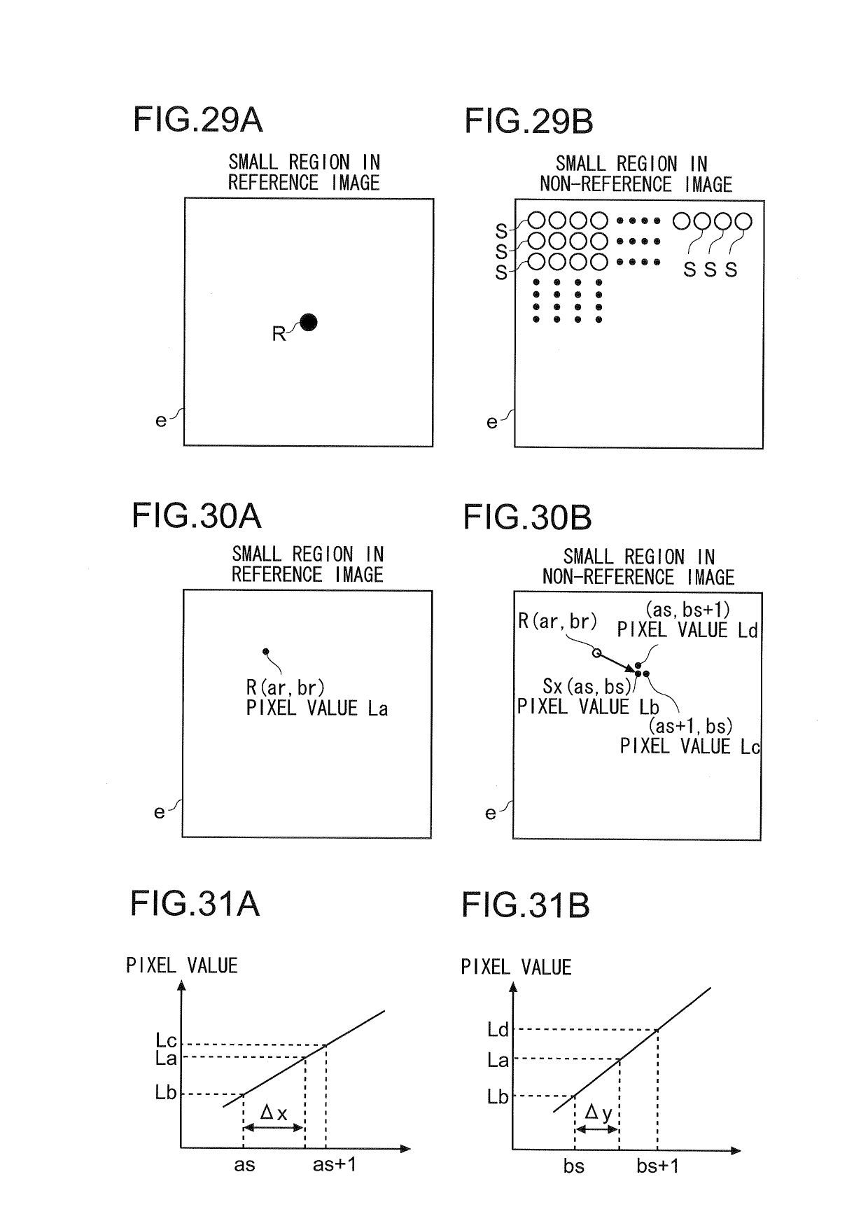

Besides, in the above process, to obtain the amount of movement (the amount of positional deviation), representative point matching and single-pixel movement amount detection, for example, as described below may be used. First, the representative point matching, and then the single-pixel movement amount detection are described with reference to drawings. FIGS. 28 and 29 are diagrams showing the representative point matching. FIG. 28 is a schematic diagram showing a method for dividing each region of an image, and FIG. 29 is a schematic diagram showing a reference image and a non-reference image.

In the representative point matching, for example, an image (reference image) serving as a reference and an image (non-reference image) compared with the reference image to detect movement are each divided into regions as shown in FIG. 28. For example, an a×b pixel group (for example, a 36×36 pixel group) is divided as one small region e, and then a p×q region portion (e.g., a 6×8 region portion) of such a small region e is divided as one detection region E. Moreover, as shown in FIG. 29A, one of the a×b pixels which constitute the small region e is set as a representative point R. On the other hand, as shown in FIG. 29B, a plurality of pixels of the a×b pixels which constitute the small region e are set as sampling points S (e.g., all of the a×b pixels may be set as the sampling points S).

After the small region e and the detection region E are set as described above, in a small region e serving as the same position in the reference and non-reference images, a difference between the pixel value at each sampling point S in the non-reference image and the pixel value at the representative point R in the reference image is obtained as a correlation value at each sampling point S. Then, for each detection region E, the correlation values at sampling points S whose relative positions with respect to the representative point R are the same between the small regions e are added up for all the small regions e which constitute the detection region E, so that a cumulative correlation value at each sampling point S is obtained. Thus, for each detection region E, the correlation values at the p×q sampling points S whose relative positions with respect to the representative point R are the same are added up, so that as many cumulative correlation values as the number of sampling points are obtained (e.g., in a case where all the a×b pixels are set as the sampling points S, a×b cumulative correlation values are obtained).

After the cumulative correlation values at the sampling points S are obtained for each detection region E, the sampling point S which is considered to have the highest correlation with the representative point R (i.e., the sampling point S which has the lowest cumulative correlation value) is detected in each detection region E. Then, in each detection region E, the movement amounts of the sampling point S and the representative point R which have the lowest cumulative correlation value therebetween are obtained based on their respective pixel positions. Thereafter, the movement amounts obtained for the detection regions E are averaged, and the average value is detected as the movement amount per pixel unit between the reference and non-reference images.

Next, the single-pixel movement amount detection is described with reference to drawings. FIG. 30 is a schematic diagram of a reference image and a non-reference image showing the single-pixel movement amount detection, and FIG. 31 is a graph showing a relationship between pixel values of a sampling point and of a representative point in a time the single-pixel movement amount detection is performed.

After the movement amount per pixel unit is detected by using, for example, the representative point matching or the like as described above, the movement amount within a single pixel can further be detected by using a method described below. For example, for each small regions e, based on a relationship between the pixel value of the pixel at the representative point R in the reference image, the pixel value of the pixel at a sampling point Sx which has a high correlation with the representative point R, and the pixel values of pixels around the sampling point Sx, it is possible to detect the movement amount within a single pixel.

As shown in FIG. 30, in each small region e, the movement amount within a single pixel is detected by using a relationship between a pixel value La at the representative point R which serves as a pixel position (ar, br) in the reference image, a pixel value Lb at a sample point Sx which serves as a pixel position (as, bs) in the non-reference image, a pixel value Lc at a pixel position (as+1, bs) adjacent to the sample point Sx in a horizontal direction and a pixel value Ld at a pixel position (as, bs+1) adjacent to the sample point Sx in a vertical direction. Here, by the representative point matching, the movement amount per pixel unit from the reference image to the non-reference image becomes a value represented by a vector quantity (as−ar, bs−br).

Besides, as shown in FIG. 31A, it is assumed that the pixel value changes linearly from the pixel value Lb to the pixel value Lc as the pixel position deviates by one pixel from a pixel which serves as the sample point Sx. Likewise, as shown in FIG. 31B, it is also assumed that the pixel value changes linearly from the pixel value Lb to the pixel value Ld as the pixel position deviates by one pixel from the pixel which serves as the sample point Sx. And, a position Δx (=(La−Lb)/(Lc−Lb)) in the horizontal direction which serves as the pixel value La between the pixel values Lb and Lc is obtained; and a vertical position Δy (=(La−Lb)/(Ld−Lb)) in the vertical direction which serves as the pixel value La between the pixel values Lb and Ld is obtained. In other words, a vector quantity represented by (Δx, Δy) is obtained as the movement amount within a single pixel between the reference and non-reference pixels.

As described above, the movement amount within a single pixel in each small region e is obtained. Then, the average value obtained by averaging the obtained movement amounts is detected as the movement amount within a single pixel between the reference image (e.g., the low-resolution raw image Fb) and the non-reference image (e.g, the low-resolution raw image Fa). Then, by adding the obtained movement amount within a single pixel to the movement amount per pixel unit obtained by the representative point matching, it is possible to calculate the movement amount between the reference and the non-reference images.

### Other Examples

Image apparatuses are described as examples of the present invention; however, the present invention is not limited to image apparatuses. For example, the present invention is applicable to an electronic apparatus such as the above reproduction image process portion 12 which has only a reproduction function to generate and reproduce an output image from an input image; and an editing function to record the generated output image and the like. However, input images and the relevant information are input into these electronic apparatuses.

In addition, for example, in the above image apparatus 1, the respective operations of the taken image process portion 6, the reproduction image process portion 12 and the like may be performed by a controller such as a microcomputer or the like. Further, all or part of the functions achieved by such a controller may be written as a program; and all or part of the functions may be achieved by executing the program on a program execution apparatus (e.g., a computer).

Besides the above cases, it is possible to achieve the image apparatus 1 shown in FIGS. 1, 18 and 19, the taken image process portions 6, 6a, 6b, the clipping set portions 60, 60a and 60b shown in FIGS. 1, 2, 18 and 19, the reproduction image process portions 12, 12b and the clipping process portions 120, 120b shown in FIGS. 1, 13 and 19 by hardware or a combination of hardware and software. Moreover, in a case where the image apparatus 1, the taken image process portions 6, 6a and 6b, the clipping set portions 60, 60a and 60b, the reproduction image process portions 12, 12b and the clipping process portions 120, 120b are achieved by using software, a block diagram of portions achieved by the software shows a functional block diagram of the portions.

Embodiments of the present invention are described above; however, the present invention is not limited to these embodiments, and it is possible to make various modifications without departing from the scope and spirit of the present invention and put into practical use.

The present invention relates to an electronic apparatus such as an image apparatus and the like, typically, a digital video camera, and more particularly, to an electronic apparatus which performs a zoom process by an image process.

What is claimed is:

1. An image apparatus comprising:
an image portion which generates an input image by taking an image;
a clipping set portion which generates relevant information related to the input image;
a recording portion which relates the relevant information to the input image and records the relevant information; and
an operation portion which inputs a command from a user;
wherein the clipping set portion includes a zoom information generation portion which generates zoom information that is a piece of information of the relevant information based on a command which indicates whether or not to apply a zoom process to the input image that is input via the operation portion at a time of taking the input image.

2. The image apparatus according to claim 1, wherein the clipping set portion includes:
a main object detection portion which detects a main object from the input image; and
a clipping region set portion which based on a detection result from the main object position information, sets a clipping region covering the main object for the input image and generates clipping region information that is a piece of information of the relevant information.

3. The image apparatus according to claim 2, wherein a size of the clipping region is set depending on at least one of detection accuracy of the main object and a size of the main object in the input image.

4. An electronic apparatus comprising:
a clipping process portion which based on relevant information related to an input image, sets a display region in the input image, and based on an image in the display region, generates an output image;
wherein
a piece of information of the relevant information is zoom information that indicates whether or not to apply a zoom process to the input image; and
the clipping process portion sets the display region based on the zoom information.

5. The electronic apparatus according to claim 4, further comprising an operation portion into which a command from a user is input;
wherein
zoom magnification information which indicates a zoom magnification in the zoom process is input via the operation portion and the clipping process portion sets the display region in the input image based on the zoom magnification information; and
the clipping set portion sets a size of the display region so as to allow the zoom magnification indicated by the zoom magnification information to be achieved.

6. The electronic apparatus according to claim 4, wherein
one piece of information of the relevant information is clipping region information which indicates a clipping region in which the main object detected from the input image is contained; and
the clipping process portion sets the display region based on the clipping region information.
